(19) United States
(12) Patent Application Publication
(10) Pub. No.: US 2022/0235262 A1
(43) Pub. Date: Jul. 28, 2022

(54) MOLECULAR SWITCHES IN POROUS NETWORKS

(71) Applicant: YEDA RESEARCH AND DEVELOPMENT CO. LTD., Rehovot (IL)

(72) Inventors: Rafal KLAJN, Rehovot (IL); Zonglin CHU, Rehovot (IL)

(73) Assignee: YEDA RESEARCH AND DEVELOPMENT CO. LTD., Rehovot (IL)

(21) Appl. No.: 17/603,653

(22) PCT Filed: Apr. 14, 2020
(86) PCT No.: PCT/IL2020/050438

§ 371 Date: Oct. 14, 2021

Related U.S. Application Data
(60) Provisional application No. 62/903,843, filed on Sep. 22, 2019.
(60) Provisional application No. 62/903,784, filed on Sep. 21, 2019.

(30) Foreign Application Priority Data
Apr. 15, 2019 (IL) 266048

(51) Int. Cl. C09K 9/02; C08J 5/04; C09D 5/29; C09D 7/40; C08K 5/23; C09D 183/04

(52) U.S. Cl. CPC C09K 9/02; C08J 5/04; C09D 5/29; C09D 7/70; C09K 2211/1014; C09D 183/04; C08J 2383/04; C08J 2205/044; C08J 2205/042; C08K 5/23

(57) ABSTRACT

This invention relates to materials and to films comprising molecular photoswitches. The films exhibit excellent photoswitchable properties in the dry state. This invention is also related to processes of making the materials and the films and to uses of the films. The invention also relates to devices and systems comprising the films of this invention.

### FIELD OF THE INVENTION

This invention relates to materials and to films comprising molecular photoswitches. The films exhibit excellent photoswitchable properties in the dry state. This invention is also related to processes of making the materials and the films, uses of the materials and films and to devices and systems comprising the films.

### BACKGROUND OF THE INVENTION

Many living organisms have the ability to adapt rapidly their structures to varying environmental conditions. For instance, chameleons and cephalopods are capable of adjusting their colors to disguise themselves or to convey messages. Inspired by natural organisms, scientists seek methods to fabricate artificial systems with on-demand functionalities. Light is an attractive trigger to achieve this goal given its high spatiotemporal resolution and its relatively noninvasive nature. To render materials light-responsive, chemists typically rely on molecular photoswitches, i.e., photoactive molecules that can be converted from one state to another in response to irradiation by light. Light of a given wavelength converts the molecules from an original state to a different state. When exposed to light of a different wavelength, the molecules can revert to their original state. In some instances, the molecules can revert to the original state through thermal relaxation in the dark. Although photochemistry in solution has been explored extensively in many classes of molecular photoswitches, key challenges remain for surface-immobilized systems. Immobilization of photoactive compounds onto solid surface is essential for the successful development of functional materials, such as light-controlled electronic devices. This approach, however, presents formidable challenges. First, the total amount of the immobilized species is very small (<1 nmol·cm⁻²) even for a surface covered with a dense monolayer. Second, steric constraints due to immobilization, limits the conformational freedom of the molecules, thus affecting or completely suppressing photoswitching. In addition, electronic coupling between the chromophores and the solid surfaces can quench the photoreaction.

### SUMMARY OF THE INVENTION

Molecular photoswitches are photoactive compounds that can be converted from one state to another with light of a given wavelength and reverted back to the original state either by irradiation with light of a different wavelength or through thermal relaxation. Although a plethora of molecular photoswitches have been investigated extensively in solution, efficient photoswitching in the solid state is arguably more important for developing novel light-responsive materials. Unfortunately, immobilization of molecular switches onto surfaces typically renders them non-switchable on account of steric hindrance and electronic coupling with the underlying surface.

In this invention, it was hypothesized that the above challenges could be addressed by roughening solid surfaces with porous networks of intertwined filaments. Guided by this idea, criteria for the choice of network material has been set. For example, in one embodiment, the material chosen was transparent for efficient photoswitching to occur. Further, the material is chosen such that it remains stable under various chemical and photochemical conditions. In addition, the network material is chosen such that the network can be generated in a facile, cost-effective manner on different types of solid surfaces.

Accordingly, this invention provides in one embodiment, a surface comprising photoswitchable molecules, wherein the photoswitchable properties of the molecules is preserved. For example, in one embodiment, it is demonstrated that roughening flat surfaces by introducing a thin layer of a porous polysiloxane network does not suppress switching for several classes of photochromic compounds that are otherwise photochemically inactive in the solid state.

In one embodiment, the porous polysiloxane network comprises intertwined filaments. In one embodiment, the porous polysiloxane network comprises nanopores.

The concept proposed here enables the transfer of photoswitchability from solution onto solid surfaces.

In one embodiment, this invention provides a device comprising:

a substrate;

a porous structure layer attached to a surface of said substrate; and

organic molecules incorporated within said porous structure;

wherein said organic molecules are photoswitchable such that when exposed to radiation of a certain wavelength, the structure of the molecules is changed.

In one embodiment, the porous structure comprises filaments. In one embodiment, the porous structure comprises filaments and has a surface area of between 10 m²/g and 10,000 m²/g.

In one embodiment, the substrate material comprises a metal, a metal alloy, a metal oxide or any combination thereof. In one embodiment, the metal oxide is selected from the group consisting of: silicon oxide, tin oxide, indium tin oxide, alumina or any combination thereof. In one embodiment, the substrate is optically transparent in the visible light range, in the UV light range, in portions thereof or in any combination thereof.

In one embodiment, the porous structure comprises polysiloxane. In one embodiment, the porous structure consists of polysiloxane. In one embodiment, the porous structure is optically transparent in the visible light range, in the UV light range or in a combination thereof. In one embodiment, the pores in said structure are micropores, nanopores or a combination thereof.

In one embodiment, the porous structure is superhydrophobic. In one embodiment, the porous structure comprises filaments. In one embodiment, the porous structure comprises a porous network of said filaments. In one embodiment, the porous network of filaments comprises polysiloxane filaments.

In one embodiment, the thickness of said porous structure layer ranges between 10 nm and 1 mm. In one embodiment, the thickness of said porous structure ranges between 0.5 μm and 10 μm. In one embodiment, the thickness of the porous structure ranges between 0.5 μm and 100 μm. In one embodiment, the thickness of the porous structure ranges between 0.1 μm and 500 μm.

In one embodiment, the molecules are selected from the group consisting of: azo compounds, spiropyrans, donor-acceptor Stenhouse adducts (DASAs), stilbenes, indigos, diarylethenes and fulgides, or any combination thereof.

In one embodiment, the azo compound is a compound of formula 1:

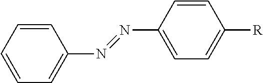

wherein R is OCH₃ (A1) or OCH₂C₂H₃ (A2) or O(CH₂CH₂O)₆(CH₂)₃SCOCH₃ (A3) or O(CH₂)₁₁SCOCH₃ (A7) or O(CH₂CH₂O)₃(CH₂)₃SCOCH₃ (A8).

In one embodiment, the azo compounds comprise compounds of formula 2:

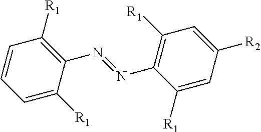

wherein R₁ is OCH₃ and R₂ is H (A4) or wherein R₁ is F and R₂ is OCH₃ (A5).

In one embodiment, the azo compounds comprise compounds of formula 3 (A6):

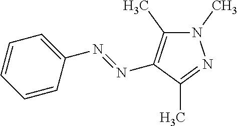 [SMILES: Cc1nn(C)c(C)c1/N=N/c1ccccc1]

In one embodiment, upon said structure (e.g. configurational) change, the absorption spectra of said molecules changes. In one embodiment, upon structure change, the molecules switch from color-visible to transparent or from transparent to color-visible. In one embodiment, upon said structure change, the molecules switch from exhibiting one color to exhibiting a different color, or wherein upon said structure change the molecules switch from exhibiting color with a certain intensity to exhibiting the same color with a different intensity.

In one embodiment, the structure change comprises transformation from a first isomer to a second isomer of said molecule. In one embodiment, the first isomer and the second isomer are stereoisomers. In one embodiment, the first isomer and said second isomer are structural isomers.

In one embodiment, the dimensions of the device parallel to the substrate surface comprise length and width ranging between 1 mm and 10 m, and the thickness of the device measured perpendicular to the substrate surface is ranging between 10 nm and 1 mm. In one embodiment, the thickness of the device measured perpendicular to the substrate surface is ranging between 10 nm and 1 cm.

In one embodiment, this invention provides a method of changing an initial color of a device, the method comprising:
providing a device comprising:
   a substrate;
   a porous structure attached to a surface of said substrate; and
   organic molecules incorporated within said porous structure;
      wherein said organic molecules are photoswitchable such that when exposed to radiation of a certain wavelength, the structure of said molecules is changed;
irradiating said device with light of a first wavelength, thus inducing molecular structural or conformation or configuration change; thereby changing the color of said device.

In one embodiment, the color change comprising change of absorption spectra of said organic molecules. In one embodiment, the substrate is transparent. In one embodiment, the irradiating wavelength is in the UV or in the visible range. In one embodiment, the color change is reversible. In one embodiment, the substrate is not transparent.

In one embodiment, the porous structure comprises filaments. In one embodiment, the porous structure comprises filaments and has a surface area of between 10 m²/g and 10,000 m²/g.

In one embodiment, ‘changing the initial color of a device’ means ‘changing the color of the device’. In one embodiment, changing the color of the device, means changing the absorption spectrum of the device. In one embodiment, changing the absorption spectrum of the device means changing the absorption spectrum in the visible range of the device. In one embodiment, the change in color of the device or the change in absorption spectrum of the device is a result of the change in color or the change in absorption spectrum of the organic molecules/photoswitches/photochromic compounds present in the device.

In one embodiment, the method further comprising irradiating said device with light of a second wavelength, thus changing the color of said device back to said initial color.

In one embodiment, after irradiating said device with light of a first wavelength, the device is kept for a period of time without being irradiated until the color of said device changes back to the initial color.

In one embodiment, this invention provides a method of preparation of a photochromic device, said method comprising:

providing a substrate;

producing porous layer on a surface of said substrate;

depositing photochromic compounds into said porous layer.

In one embodiment, the substrate comprises SiO₂. In one embodiment, the porous layer comprising polysiloxane nanofilaments.

In one embodiment, the porous structure comprises filaments. In one embodiment, the porous structure comprises filaments and has a surface area of between 10 m²/g and 10,000 m²/g.

In one embodiment, the filaments are nanofilaments.

In one embodiment, the producing step comprises vapor deposition of a chemical precursor on said substrate or dip coating of a chemical precursor from liquid solution onto the substrate. In one embodiment, the chemical precursor is trichloromethylsilane. In one embodiment, the solvent of said chemical precursor solution comprises toluene.

In one embodiment, the photochromic compounds are deposited from a liquid solution, and the solvent of said solution is toluene.

In one embodiment, this invention provides a smart window comprising the device as claimed herein, wherein the substrate is transparent in the visible light range and wherein the lateral length and width of the smart window measured parallel to said surface of said substrate ranging between 1 cm to 10 m.

In one embodiment, this invention provides an optical switch comprising:

a device as claimed herein, wherein the substrate is transparent in the visible-light range;

an irradiation source.

In one embodiment, this invention provides a memory device or an encoder comprising:

a device as claimed herein, wherein the substrate is transparent in the visible-light range;

an irradiation source;

an optical detector.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1F show the process of dispersing molecular photoswitches on glass slides roughened by polysiloxane nanofilament networks, FIG. 1A: schematic illustration of decorating planar substrates with a nanoporous layer of polysilsesquioxane nanowire networks (PNNs) and inserting photoswitchable molecules (here, azo compounds A1-A6) into/onto the network via physical adsorption; FIG. 1B representative scanning electron microscopy (SEM) images (top (left) and side (right) views) of PNNs on a glass substrate. The images show the polysiloxane nanofilament coating on the substrate. FIG. 1C: solid-state UV/Vis spectra of PNN-roughened glass after immersion in toluene solutions of A1. A1 is adsorbed on the roughened surfaces by dip-coating the roughened glass in solutions of increasing A1 concentrations (1.7 to 38.2 mM, A1 is ‘1’ in the figure) highest peak corresponds to the highest concentration and the lowest peak to the lowest concentration; FIG. 1D: dependence of the surface concentration σ₁ of 1, on PNN-roughened glass as a function of c₁, the concentration of A1 in the solution used for adsorption. inset: a sample of freestanding PNNs. FIG. 1E: Absorbance, Abs_{343 nm}, plotted as a function of surface density of A1 (σ_{A1}) on a polysiloxane nanofilament network-roughened glass slide. FIG. 1F: a series of SEM images of PNNs deposited on a silica coated Si wafer subjected to heating inside an environmental scanning electron microscope (note that it was intentionally focused on a non-uniform region of the sample to facilitate the comparison of the frames.

FIGS. 2A-2G show photoresponsive properties of A1 on a polysiloxane nanofilament network-roughened glass slide (at σ=21.7 nmol·cm⁻²); FIG. 2A: shows reversible isomerization of azobenzene A1. FIG. 2B: Evolution of solid-state UV/Vis spectra of a PNN-roughened glass slide doped with trans-A1 (σ₁=21.7 nmol/cm²) upon exposure to UV light (λ=365 nm). FIG. 2C: Changes in UV/Vis spectra upon subsequent exposure to blue light (λ=460 nm). (σ=21.7 nmol·cm⁻²); FIG. 2D: changes in absorbance at 343 nm (Abs_{343 nm}) (proportional to the content of the trans isomer) plotted as a function of irradiation time (UV followed by blue light. FIG. 2E: thermal relaxation of surface-confined A1 (5-min intervals between the spectra), inset: changes in the absorbance at 343 nm as a function of time, demonstrating first-order reaction kinetics); FIG. 2F: ten cycles of reversible photoswitching of surface-confined A1 (each cycle consisted of 3 min of UV exposure, followed by 2 min of blue light); FIG. 2G: first-order reaction kinetics of the thermal back-isomerization; FIG. 2H: NMR spectra of UV- and blue-adapted photostationary states.

FIGS. 3A-3I shows photoresponsive properties of spiropyran (8) on a polysiloxane nanofilament network-roughened glass slide (σ=18.2 nmol·cm⁻²); FIG. 3A: chemical structures of the two isomers. FIG. 3B: changes in absorbance at 554 nm (proportional to the content of the 8′ isomer) of a PNN-roughened glass slide doped with 8 (σ₈=18.2 nmol/cm²) as a function of UV and green light irradiation time; FIG. 3C: Changes in the wavelength of the maximum absorption of 8′ within PNNs as a function of UV irradiation time; FIGS. 3D-3E: Schematic illustration of a write-erase cycle on an 8-doped, PNN-roughened glass using UV light (with a mask) and green light, respectively. Five images created consecutively in an 8-doped, PNN-roughened glass slide by exposing it to UV light through different masks; FIG. 3F: changes in the absorption spectra upon exposure to UV light (365 nm) highest peak corresponds to UV=420 s, and lowest peak to the initial. FIG. 3G: changes in the absorption spectra upon exposure to green light (520 nm) following a UV exposure; FIG. 3H: ten cycles of reversible switching of spiropyran followed by monitoring Abs_{554 nm}; FIG. 3I: Photographs of a PNN-roughened 50 μm-thick polypropylene sheet (48 mm×26 mm) doped with 8 and exposed to UV light (through a mask) for 10 min.

FIG. 4 shows steps of preparation of roughened surfaces comprising photoswitchable molecules and photoswitching induced by light.

FIG. 5 shows ¹H NMR spectrum of A5 (=compound 3) (400 MHz, CDCl₃). δ=7.35-7.27 (m, 1H), 7.03 (t, 2H), 6.61-6.58 (d, 2H), 3.88 (s, 3H).

FIG. 6 shows ¹³C NMR spectrum of A5 (=compound 3) (100 MHz, CDCl₃); δ=162.78 (t, 3JCF=14.0 Hz), 157.61 (dd, 1JCF=259.9 Hz, 3JCF=7.1 Hz), 155.63 (dd, 1JCF=257.6 Hz, 3JCF=4.3 Hz), 132.25 (t, 2JCF=10.0 Hz), 130.52 (t, 3JCF=10.3 Hz), 126.17 (t, 2JCF=9.4 Hz), 112.65 (m), 99.07 (dd, 2JCF=24.0 Hz, 4JCF=3.1 Hz), 56.34 (s). HRMS calcd for C13H9F4N2O [M+H]+, m/z=285.0651; found, 285.0645.

FIG. 7 shows solid-state UV/Vis absorption spectrum of A1 (=compound 1) deposited on a polysiloxane nanofilament network-coated glass slide (blue-high peak between 300 nm and 400 nm) and on bare glass slide (red-lower small bump between 300 nm and 400 nm). A bare glass slide dipped in a 12 mM toluene solution of 1 vs a PNN-roughened glass slide (SNF-coated glass slide) dipped in the same solution.

FIG. 8 shows UV/Vis absorption spectrum of a polysiloxane nanofilament network-coated glass slide onto which A1 (=compound 1) was adsorbed; Blue: UV/Vis absorption spectrum of a PNN-glass slide following dipping in a 12 mM toluene solution of 1. Red: UV/Vis spectrum of the same slide after washing with toluene (see arrows). Inset is magnification of the lower part of the graph.

FIGS. 9A-9E show photoresponsive (isomerization) properties of A2 (=Compound 4) on a polysiloxane nanofilament network (PNN)-roughened glass slide (at σ=22.1 nmol·cm⁻²); (FIG. 9A): UV/Vis absorption spectra of a PNN-roughened glass slide doped with 4 before exposure to light (gray trace, initial), after exposure to UV (365 nm; purple trace), and after subsequent exposure to blue light (460 nm; blue trace); (FIG. 9B): Changes in the absorbance at 343 nm (proportional to the content of trans-4) as a function of UV (0→300 s) and blue light (300→480 s) irradiation time; (FIG. 9C): Ten cycles of reversible photoisomerization of 4 on PNN-roughened glass (2 min of UV light followed by 15 sec of blue light were applied in each cycle). (FIG. 9D): Kinetics of thermal back-isomerization of cis-4 on PNN-roughened glass (A=absorbance at 343 nm; red line=linear fit; R2=0.999). (FIG. 9E): NMR spectra of solutions obtained by washing 4-doped, PNN-roughened glass with CDCl₃ after exposure to UV (top) and blue light (bottom).

FIGS. 10A-10E shows photoresponsive properties of A3 (=Compound 7) on a polysiloxane nanofilament network-roughened glass slide (at σ=18.8 nmol·cm⁻²); (FIG. 10A): UV/Vis absorption spectra of a PNN-roughened glass slide doped with 7 before exposure to light (gray trace, initial), after exposure to UV (365 nm; purple trace), and after subsequent exposure to blue light (460 nm; blue trace). (FIG. 10B) Changes in the absorbance at 345 nm (proportional to the content of trans-7) as a function of UV (0→300 s) and blue light (300→480 s) irradiation time. (FIG. 10C) Ten cycles of reversible photoisomerization of 7 on PNN-roughened glass (2 min of UV light followed by 15 sec of blue light were applied in each cycle). (FIG. 10D) Kinetics of thermal back-isomerization of cis-7 on PNN-roughened glass (A=absorbance at 345 nm; red line=linear fit; R2=0.991). (FIG. 10E) NMR spectra of solutions obtained by washing 7-doped, PNN-roughened glass with CDCl₃ after exposure to UV (top) and blue light (bottom).

FIGS. 11A-11E shows photoresponsive (isomerization) properties of A4 (=Compound 2) on a polysiloxane nanofilament network-roughened glass slide (at σ=23.8 nmol·cm⁻²); (FIG. 11A) UV/Vis absorption spectra of a PNN-roughened glass slide doped with 2 before exposure to light (gray trace), after exposure to green light (520 nm; green trace), and after subsequent exposure to blue light (420 nm; blue trace) blue trace follows the initial trace. (FIG. 11B) Changes in absorbance at 303 nm (proportional to the content of trans-2) as a function of green (0→180 s) and blue light (180→360 s) irradiation time. (FIG. 11C) Ten cycles of reversible photoisomerization of 2 on PNN-roughened glass (15 s of green light followed by 15 sec of blue light were applied in each cycle). (FIG. 11D) Kinetics of the thermal back-isomerization of cis-2 on PNN-roughened glass (A=absorbance at 330 nm; red line=linear fit; R2=0.993). (FIG. 11E) NMR spectra of solutions obtained by washing 2-doped, PNN-roughened glass with DMSO-d6 after exposure to green (top) and blue light (bottom).

FIGS. 12A-12E shows photoresponsive (isomerization) properties of A5 (=Compound 3) on a polysiloxane nanofilament network (PNN)-roughened glass slide (at σ=20.3 nmol·cm⁻²); (FIG. 12A) UV/Vis absorption spectra of a PNN-roughened glass slide doped with 3 before exposure to light (gray trace, initial), after exposure to green light (520 nm; green trace), and after subsequent exposure to blue light (420 nm; blue trace). (FIG. 12B) Changes in the absorbance at 327 nm (proportional to the content of trans-3) as a function of green (0→120 s) and blue light (120→240 s) irradiation time. (FIG. 12C) Ten cycles of reversible photoisomerization of 3 on PNN-roughened glass (10 s of green light followed by 15 sec of blue light were applied in each cycle). (FIG. 12D) Kinetics of thermal back-isomerization of cis-3 on PNN-roughened glass (A=absorbance at 327 nm; red line=linear fit; R2=0.919). (FIG. 12E) NMR spectra of solutions obtained by washing 3-doped, PNN-roughened glass with CDCl₃ after exposure to green (top) and blue light (bottom).

FIGS. 13A-13E shows photoresponsive (isomerization) properties of A6 (=Compound 9) on a polysiloxane nanofilament network-roughened glass slide (at σ=20.6 nmol·cm⁻²); (FIG. 13A) UV/Vis absorption spectra of a PNN-roughened glass slide doped with 9 before exposure to light (gray trace), after exposure to UV light (purple trace), and after subsequent exposure to green light (green trace) green trace follows predominantly the initial trace but with a lower peak. (FIG. 13B) Changes in absorbance at 343 nm (proportional to the content of trans-9) as a function of UV (0→300 s) and green light (300→360 s) irradiation time. (FIG. 13C) Ten cycles of reversible photoisomerization of 9 on PNN-roughened glass (2 min of UV light followed by 10 sec of green light were applied in each cycle). (FIG. 13D) Kinetics of thermal back-isomerization of cis-9 on PNN-roughened glass (A=absorbance at 330 nm; red line=linear fit; R2=0.990). (FIG. 13E) NMR spectra of solutions obtained by washing 9-doped, PNN-roughened glass with CDCl₃ after exposure to UV (top) and green light (bottom).

FIGS. 14A-14B shows kinetics of thermal back-isomerization of A1 (=Compound 1) (FIG. 14A) and the reaction rate constants (k) and half-lives of cis-isomer (τ_{1/2}) (FIG. 14B) in solvents of varied polarity.

FIG. 15 shows comparison of thermal relaxation kinetics of A4 in a DMSO solution (right) and on a polysiloxane nanofilament network-coated glass surface (left).

FIGS. 16A-16G shows the effect of azobenzene substitution on the kinetics of thermal relaxation in DMSO solution and on the polysiloxane nanofilament network-coated glass surface; (FIG. 16A) structural formulas of azobenzenes studied and back-isomerization rate constants in solution (kₛₒₗ) and on the surface (κ_{surf}); (FIG. 16B) to (FIG. 16F) are relaxation profiles of the five azobenzenes in solution vs. on the surface; (FIG. 16G) relaxation profile of A1 dispersed on glass coated with native (left) vs. plasma-oxidized polysiloxane nanofilament networks (right, SNF-OH).

FIG. 17 shows UV/Vis spectra of spiropyran deposited on a polysiloxane nanofilament network-roughened surface before and after exposure to 1 μW·cm⁻² and 6 μW·cm⁻² UV light for 10 min.

FIGS. 18A-18L shows: (FIG. 18A) gradual and spontaneous disappearance of an image created by exposing a polysiloxane nanofilament network-roughened glass slide containing spiropyran (compound 8) by exposing it to 0.1 mW/cm² UV light for 10 min. (FIG. 18B) spontaneous decay of visible light absorbance (Abs_{554 nm}) (the horizontal lower red dots line represent Abs_{554 nm} prior to UV light irradiation; (FIG. 18C) Kinetics of thermal back-isomerization of spiropyran (8) on a polysiloxane nanofilament network-roughened glass slide pre-exposed to UV light; (FIG. 18D) UV/Vis spectra of samples pre-irradiated with 0.5 min and 10 min UV light (0.7 mW·cm⁻²); (FIG. 18E) Following the thermal relaxation after exposing the samples to 0.5 min and 10 min UV light (0.7 mW·cm⁻²); (FIG. 18F) and (FIG. 18G)) comparison between the kinetics of thermal relaxation of a sample exposed to 30 sec vs. 10 min of UV light. (FIG. 18H) Evolution of solid-state UV/Vis spectra of a PNN-roughened glass slide doped with 8 (σ=18.2 nmol/cm²) upon exposure to UV light (λ=365 nm). (FIG. 18I) Evolution of UV/Vis spectra of a UV-adapted PNN-roughened glass slide doped with 8 upon exposure to green light (λ=520 nm). (FIG. 18J) Five cycles of reversible photoisomerization of 8 on PNN-roughened glass. (FIG. 18K) Kinetics of the thermal back-isomerization of 8′ (see FIG. 3A) on PNN-roughened glass (A=absorbance at 554 nm). 8′ was generated by exposing 8-doped, PNN-roughened glass to 0.1 mW/cm² UV light for 10 min. (FIG. 18L) Kinetics of the thermal back-isomerization of 8′ generated by exposing 8-doped, PNN-roughened glass slides to 0.7 mW/cm² UV light for 30 sec vs. 10 min.

FIGS. 19A-19C shows: (FIG. 19A) Structural formulas of azobenzenes 2-7 (Ac=COCH₃). A7=compound 5 and A8=compound 6. (FIG. 19B) Thermal half-lives, τ_{1/2}, of the cis isomers of 1-7 on PNN-roughened glass (blue, left columns for each) and in DMSO solution (red, right columns for each). (FIG. 19C) Acceleration factor, χ, defined as the ratio of back-isomerization rate constant in PNNs vs. DMSO solution, for compounds 1-7.

FIGS. 20A-20B shows (FIG. 20A) N₂ physisorption isotherms of PNNs at 77 K; (FIG. 20B) Rouquerol plot for PNNs.

FIGS. 21A-21C shows (FIG. 21A) Solvent-dependent kinetics of thermal back-isomerization of cis-1 (A=absorbance at 343 nm; τ_{1/2}=2.0 h for PNN-coated glass, 31.7 h for hexane, 34.1 h for toluene, 48.5 h for DMSO, and 65.4 h for methanol; red lines represent linear fits; R2=0.990 for PNN-roughened glass and 0.999 for all the liquid solvents). (FIG. 21B) Ten cycles of reversible photoisomerization of 1 on PNN-roughened glass (3 min of UV light, followed by 2 min of blue light were applied in each cycle). (FIG. 21C) NMR spectra of solutions obtained by washing 1-doped, PNN-roughened glass with CDCl₃ after exposure to UV (top) and blue light (bottom).

FIGS. 22A-22F shows (FIG. 22A) Kinetics of thermal back-isomerization of cis-1 in DMSO vs. on PNN-roughened glass (A=absorbance at 343 nm; red lines=linear fits; R2=0.999 for DMSO and 0.996 for PNN). Acceleration factor, χ=24.8. (FIG. 22B) Kinetics of thermal back-isomerization of cis-2 in DMSO vs. on PNN-roughened glass (A=absorbance at 330 nm; red lines=linear fits; R2=0.981 for DMSO and 0.993 for PNN); χ=27.0. (FIG. 22C) Kinetics of thermal back-isomerization of cis-4 in DMSO vs. on PNN-roughened glass (A=absorbance at 343 nm; red lines=linear fits; R2=0.999 for DMSO and 0.999 for PNN); χ=4.53. (FIG. 22D) Kinetics of thermal back-isomerization of cis-5 in DMSO vs. on PNN-roughened glass (A=absorbance at 345 nm; red lines=linear fits; R2=0.999 for DMSO and 0.992 for PNN); χ=2.29. (FIG. 22E) Kinetics of thermal back-isomerization of cis-6 in DMSO vs. on PNN-roughened glass (A=absorbance at 345 nm; red lines=linear fits; R2=0.999 for DMSO and 0.995 for PNN); χ=1.95. (FIG. 22F) Kinetics of thermal back-isomerization of cis-7 in DMSO vs. on PNN-roughened glass (A=absorbance at 345 nm; red lines=linear fits; R2=0.999 for DMSO and 0.991 for PNN); χ=1.67.

FIGS. 23A-23F shows (FIGS. 23A-23E) Kinetics of thermal back-isomerization of cis-3 in DMSO at different temperatures (black lines=linear fits; R2=0.996 (FIG. 23A), 0.996 (FIG. 23B), 0.990 (FIG. 23C), 0.987 (FIG. 23D), and 0.998 (FIG. 23E)). (FIG. 23F) Determination of the rate constant for thermal back-isomerization of cis-3 at 23° C. (dashed line=linear fit; R2=0.999 both with and without the 23° C. point). A=absorbance at 336 nm.

FIG. 24 shows Kinetics of thermal back-isomerization of cis-1 in DMSO (gray markers, highest, right-most graph); red line crossing markers=linear fit; R2=0.999), on PNN-coated glass (white markers, left-most graph; red line crossing markers=linear fit; R2=0.999), and on the same PNN-coated glass treated with oxygen plasma for 3 min (green markers, central graph; red line crossing markers=linear fit; R2=0.986). A=absorbance at 343 nm.

FIG. 25 shows UV/Vis transmittance of sunlight through visible and UV filters used in embodiments of this work.

FIGS. 26A-26C shows (FIG. 26A) Solid-state UV/Vis spectra of a 1-doped, PNN-roughened glass slide following exposure to sunlight through a visible filter (transparent to UVA light, 320-400 nm) for 3 min (lowest peak) and subsequent exposure to sunlight through a UV filter (400 nm cutoff) for 1 min (central peak). (FIG. 26B) Changes in absorbance at 343 nm as a function of sunlight exposure time. (FIG. 26C) NMR spectra of solutions obtained by washing 1-doped, PNN-roughened glass with CDCl₃ after exposure to sunlight through a visible filter (top) and a UV filter (bottom).

FIG. 27 shows Representative SEM images of PNNs on ITO (left), on aluminum (center), and on iron (right) and the compositions of photostationary states of 1 under sunlight exposure with visible and UV filters.

FIGS. 28A-28B shows (FIG. 28A) Photograph of an initially transparent 8-doped PNN-roughened glass slide following exposure to sunlight for 30 s. (FIG. 28B) Photographs of four PNN-roughened glass slides doped with 8, following exposure to sunlight for increasing amounts of time.

FIG. 29 Kinetics of thermal back-isomerization of cis-9 in DMSO (A=absorbance at 330 nm; red line=linear fit; R2=0.995).

FIG. 30 Embodiments of devices, systems and apparatuses of the invention with illustration of various optional elements/components.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Transferring solution behaviors of molecular photoswitches to surfaces is of crucial importance for the development of functional materials. However, the amount of chromophores that can be adsorbed on planar surfaces is very limited and adsorption typically renders the chromophores photochemically inactive. In one embodiment, this invention shows that by derivatizing glass slides with thin films of transparent polysiloxane nanofilament networks, the loading of chromophores can be increased by nearly two orders of magnitude. More importantly, molecular switches within these networks retain excellent photoswitchable properties even in the dry state.

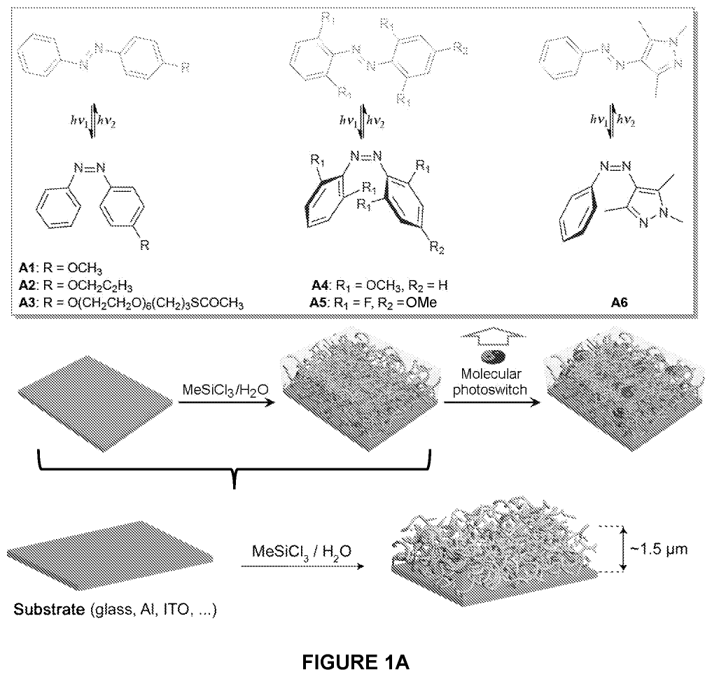

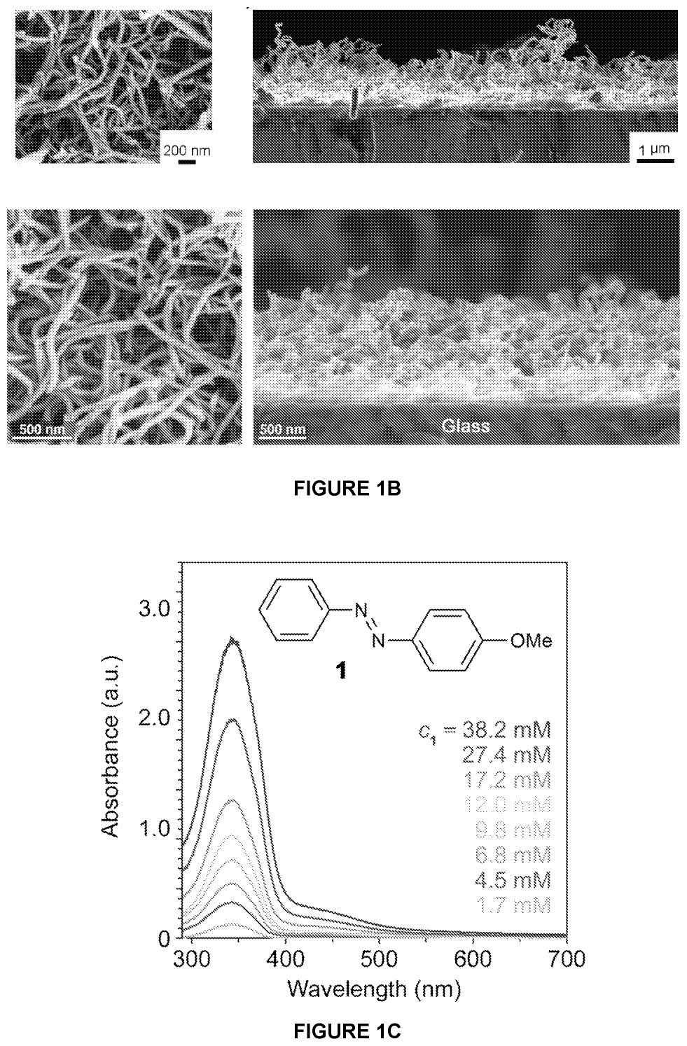

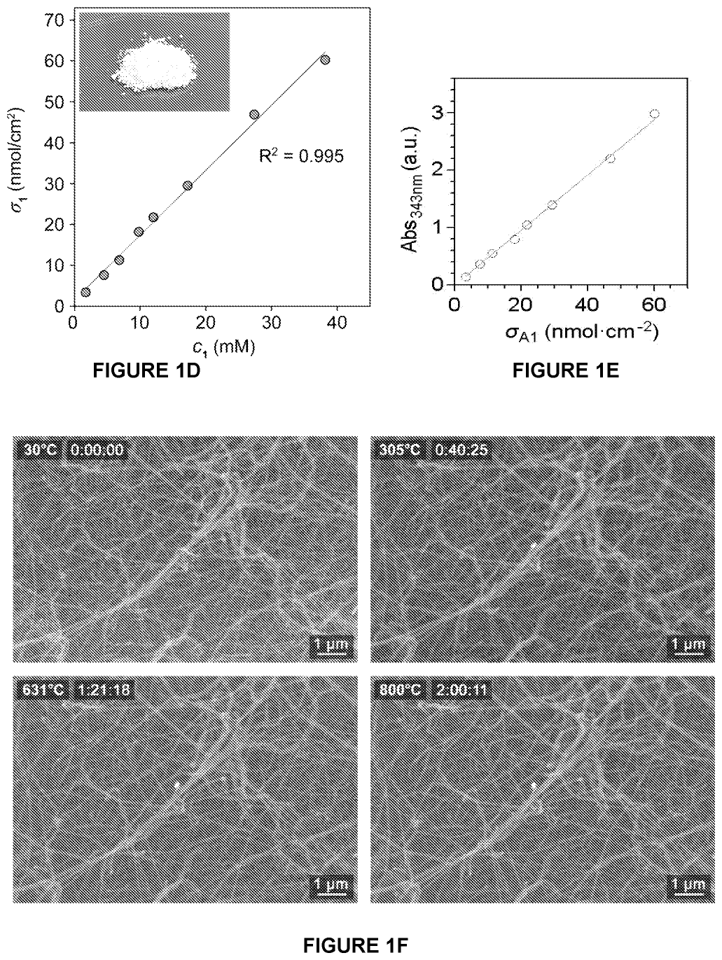

In one embodiment, as a model solid substrate, glass slides were selected. The glass slides were roughened with polysiloxane nanofilament networks (FIG. 1A). FIGS. 1B and 1C show representative scanning electron microcopy (SEM) images of a polysiloxane nanofilament network layer, whose thickness was estimated as ˜1.6 Photoswitchable molecules were dispersed on/within the polysiloxane nanofilament network-roughened glass surface by dipping the glass slide in a solution of the corresponding chromophore in toluene and subsequent drying in air. The initial studies were performed with a structurally simple azobenzene A1.

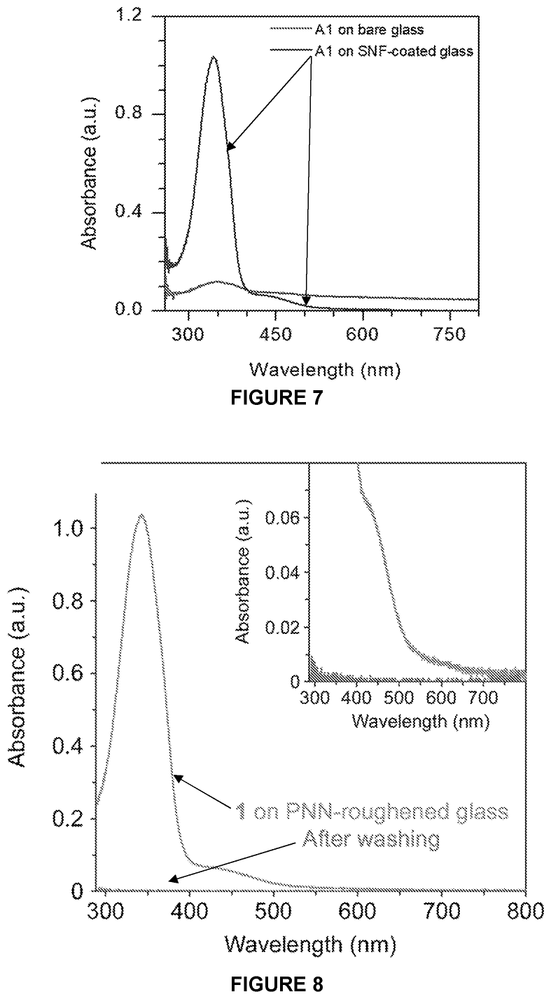

The excellent transparency of polysiloxane nanofilament network-coated glass slides in the visible and near-UV regions allows us to study the spectroscopic behavior of the adsorbed chromophores by means of UV/Vis absorption spectroscopy. FIG. 1D shows representative UV/Vis spectra obtained by dip-coating polysiloxane nanofilament network-coated slides in solutions of A1 at increasing concentrations. The spectra exhibit strong absorption band at ˜343 nm due to π→π* transition in trans-A1, typical of A1 in an organic solvent (λ_{π→π*}≈342 nm in hexane), which implies that A1 is well dispersed within the polysiloxane nanofilament networks. In contrast, the same compound absorbed on bare glass slides showed significant increase in the absorption at higher wavelengths, indicative of aggregation and/or crystallization (see FIG. 7).

Interestingly, it was found that the absorbance at 343 nm (Abs_{343 nm}) increased linearly with increasing concentration of the stock solution (FIG. 1E). In order to precisely determine the amount of A1 absorbed onto the surface, the surface was thoroughly washed with a solvent and the obtained solution was analyzed by UV/Vis spectroscopy (see also FIG. 8). For example, it was determined that dipping the slide in a 12 mM stock solution resulted in the adsorption of 633 nmol of A1 onto the slide, corresponding to a surface density (σ) of 21.7 nmol·cm⁻². Increasing the concentration of the stock solution to 38.2 mM resulted in σ=60.3 nmol·cm⁻², corresponding to a coverage as much as two orders of magnitude higher than that typical of a densely packed monolayer on a flat surface. It was also found that Abs_{343 nm} showed a linear dependence on a (FIG. 1E). The molar absorption coefficient of immobilized A1 was determined as ε_{surf}=2.40×10⁷ cm²·mol⁻¹ (Example 3, Equation E3). Importantly, this value is nearly identical to the absorption coefficient of A1 in solution (ε=2.45×10⁷ cm²·mol⁻¹ in toluene), further confirming that A1 within polysiloxane nanofilament networks persists in a well-dispersed state.

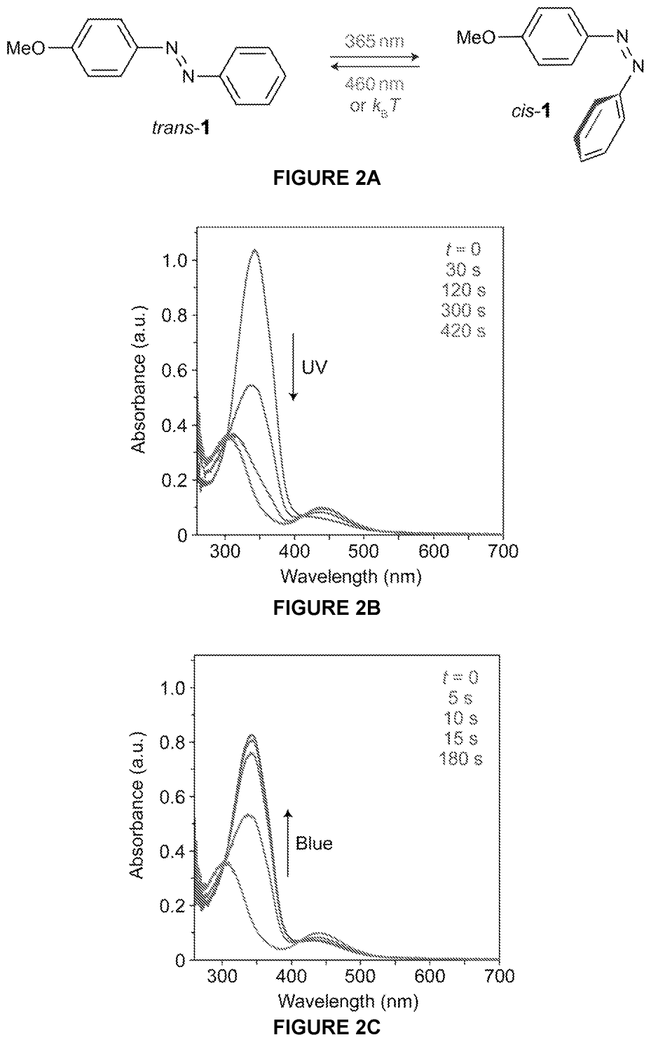

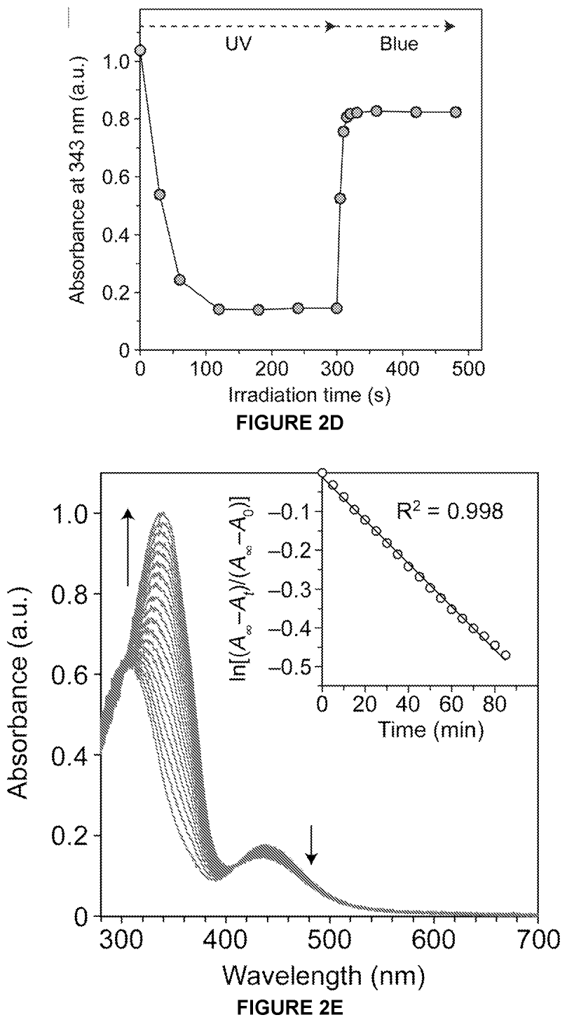

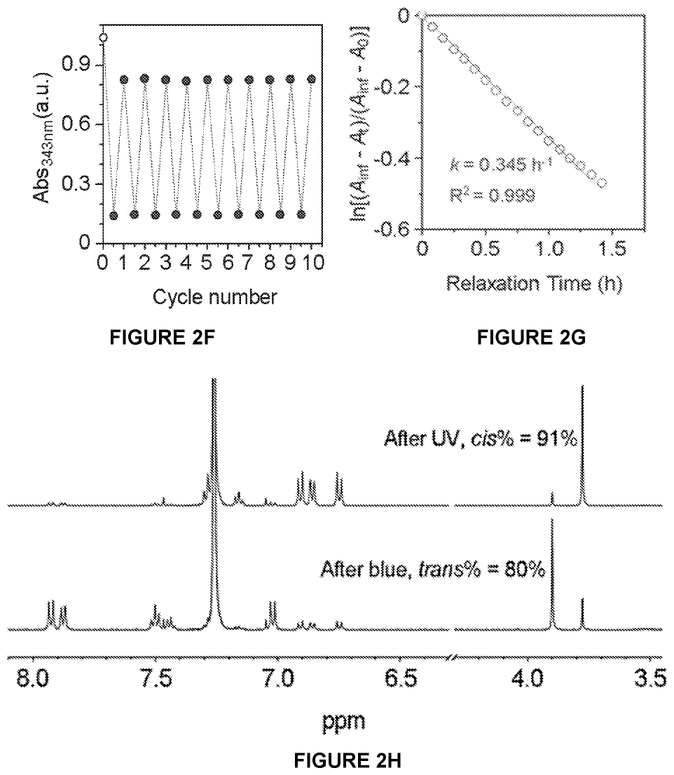

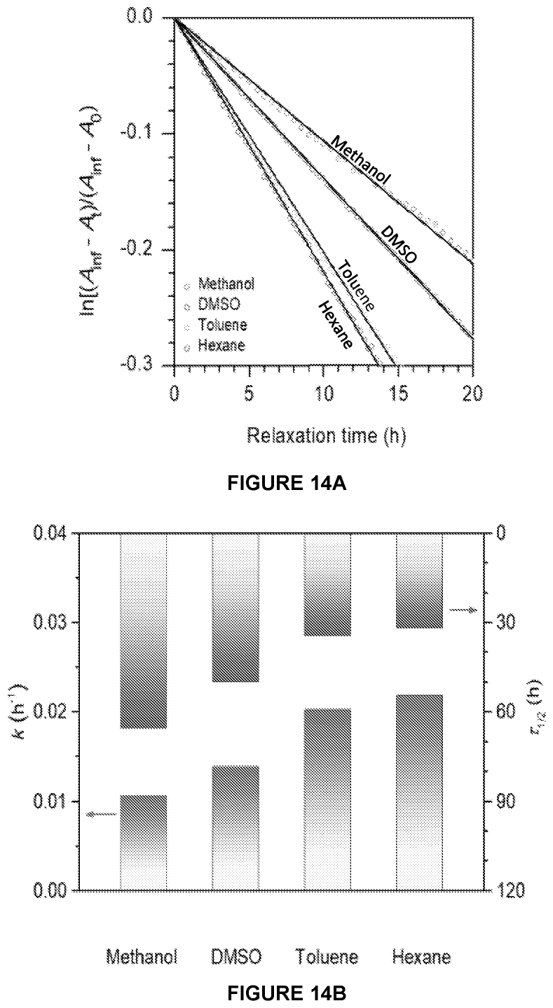

UV/Vis absorption spectroscopy was used to verify whether A1 adsorbed on polysiloxane nanofilament network-derivatized glass details its photoswitchable properties. FIG. 2 shows the changes of the absorption spectra of A1 upon UV light irradiation, whereby the intensity of the π→π* band decreased, while that of the n→π* band increased with increasing UV irradiation time, indicative of the trans→cis isomerization (FIG. 2A). Subsequent exposure to visible (blue) light irradiation resulted in the reverse reaction (FIGS. 2B and 2C). Importantly, immobilized A1 exhibited excellent reversibility: No decrease in Abs_{343 nm} was observed after ten cycles of UV/blue light irradiation (FIG. 2F). Thermal relaxation of cis-A1 in the dark was also studied, as shown in FIG. 2G. It was found that the relaxation followed first-order kinetics (FIG. 2G), which can be described as:

$$ln \frac{{A}_{inf} - {A}_{t}}{{A}_{inf} - {A}_{0}} = - kt \qquad ( E1 )$$

where A_{inf}, A₀ and Aₜ denote the absorbance at 343 nm before irradiation, immediately after the UV irradiation is ceased, and after thermal relaxation time t, and k is the rate constant of thermal back-isomerization. Using this equation, the half-life of the A1 cis-isomer (τ_{1/2}) was determined as 2.0 h, an unusually small value for azobenzenes, which typically exhibit τ_{1/2} in the range of 32-65 h in solution (see FIG. 14 and the discussion below).

To determine the compositions of the UV- and blue-adapted photostationary states (PSSs), A1 was desorbed by washing the slides thoroughly with a deuterated solvent (CDCl₃ unless stated otherwise) immediately after light irradiation and the obtained solutions were analyzed by ¹H NMR spectroscopy. As much as 91% trans and 80% cis isomers have been found in samples exposed to UV and blue light, respectively. Importantly, the compositions of the PSSs held for the intensely yellow-colored substrates with A1 surface densities as high as 60.3 nmol·cm⁻².

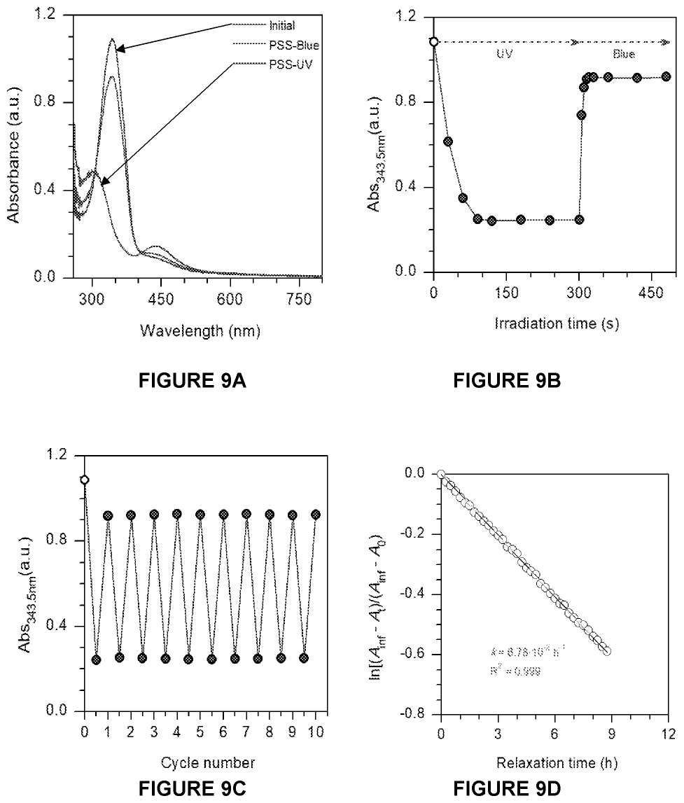

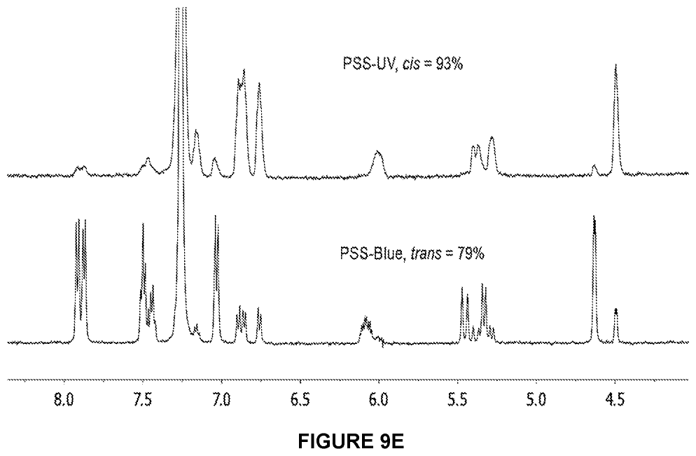

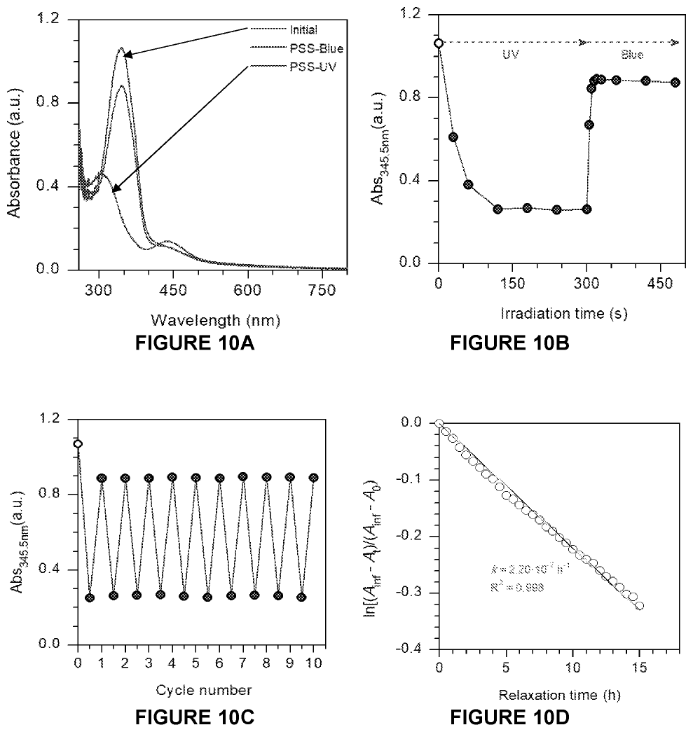

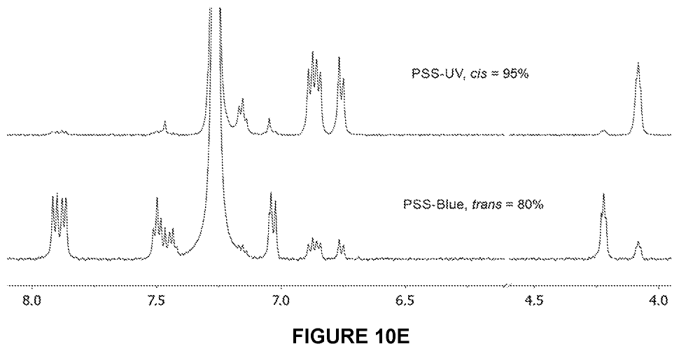

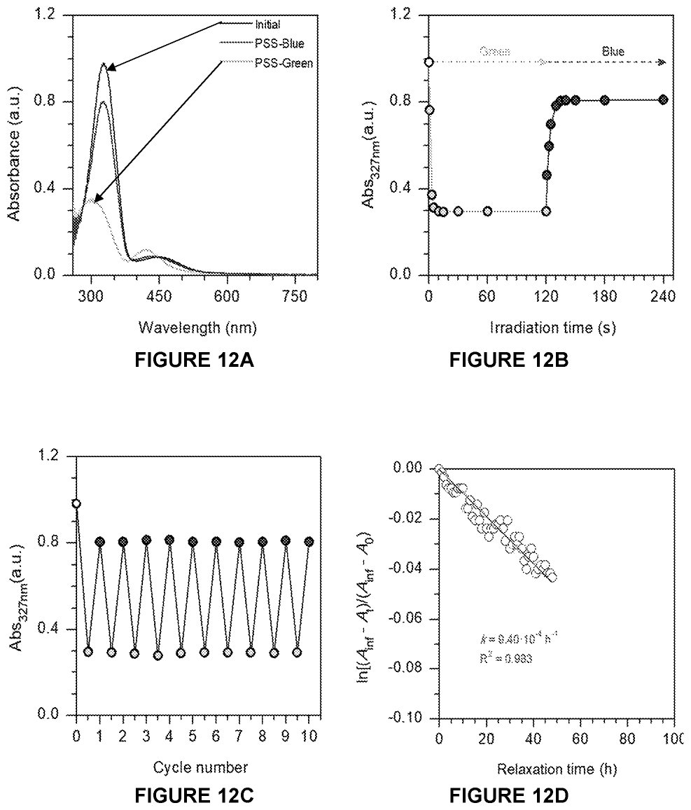

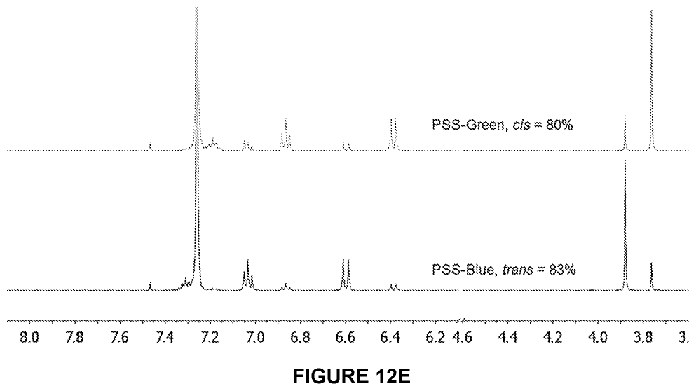

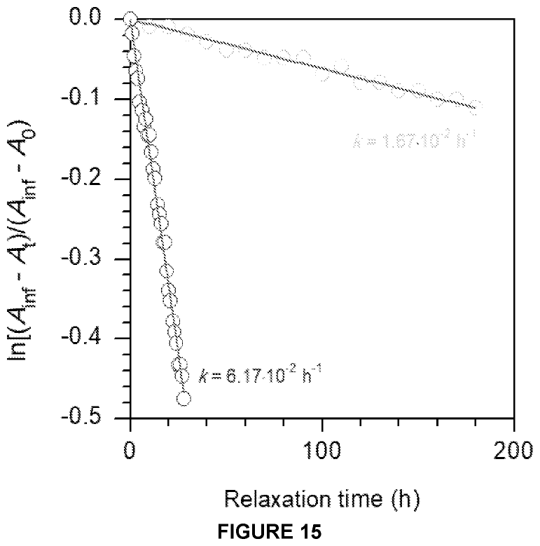

To illustrate the applicability of the porous polysiloxane nanofilament network in dispersing and enabling the photoswitching of other photochromic compounds, several other azo derivatives were immobilized (see FIG. 1A: A2, A3 appended with a long chain, red-shifted derivatives, A4 and A5, and azopyrazole A6) on the surface of polysiloxane nanofilament network-coated glass slides. In all cases, the immobilized photoswitches showed excellent photoresponsive properties with high reversibility (FIGS. 9-13 and Table 1). Interestingly, the acceleration of thermal back-isomerization was observed for all the immobilized azo compounds. For example, thermal half-life of A4 decreased by a factor of 27-fold upon immobilization (FIG. 15); A5 dispersed in the porous network showed half-life of ˜1 month (considerably shorter than the ˜2 years reported for a DMSO solution), and the cis-isomer of azopyrazole A6, previously reported with half-life of 10 days in acetonitrile, exhibited τ_{1/2} of only 15 h on the polysiloxane nanofilament network-coated glass slide.

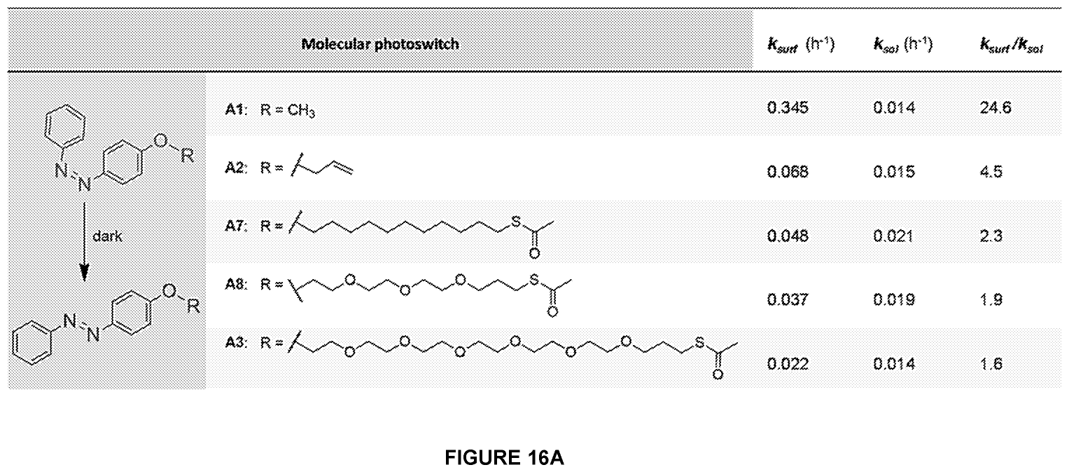

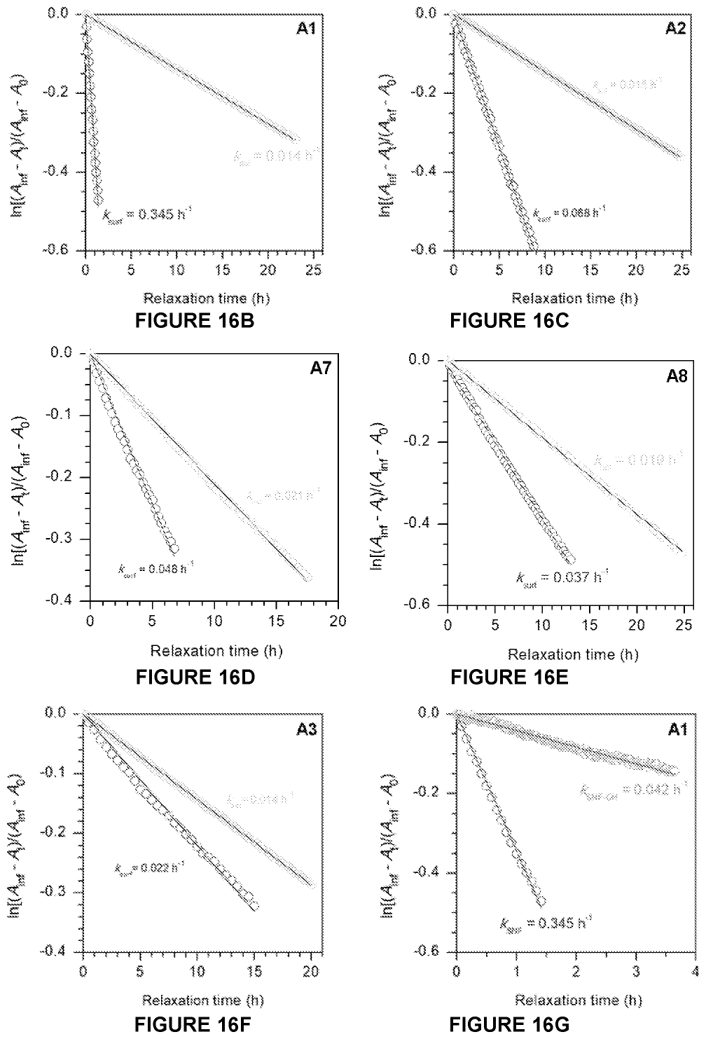

It is well known that the isomerization of azobenzenes is largely affected by the local environment. For instance, polar environment can efficiently stabilize the cis form of azobenzene, thus decreasing the rate of thermal relaxation. It was also reported that the amount of free volume around the azo moiety can have a significant impact on the isomerization kinetics. Without being limited to any theory, it is suggested that the accelerated thermal back-isomerization observed in this work can be attributed to a combination of the high hydrophobicity of the polysiloxane nanofilament network layer and reduced steric hindrance exhibited by the chromophore. These considerations are supported by the behavior of compound A3, in which a hexa(ethylene glycol) chain was installed, which increases the polarity in the immediate vicinity of the chromophore moiety while reducing the free volume around it. It was found that whereas the back-isomerization rate constants of cis-A1 and cis-A3 were identical in solution (DMSO; FIG. 16), the remarkable acceleration in the immobilized state was observed for A1 only (˜25 times vs. ˜1.6 times for A3; FIG. 16A).

The above considerations led to speculate that the back-isomerization reaction could be slowed down if the coating's surface polarity increased. Therefore, hydroxyl groups on the surfaces of polysiloxane nanofilament networks were generated via oxygen plasma treatment prior to depositing A1. Indeed, it was found that this procedure led to an increase of the τ_{1/2} of A1 from ˜2.0 h to ˜16.5 h (FIG. 16G). These results highlight the possibility of manipulating the thermal back-isomerization rate by either altering the structure of the azo compound or by changing surface chemistry of the polysiloxane nanofilament network coating.

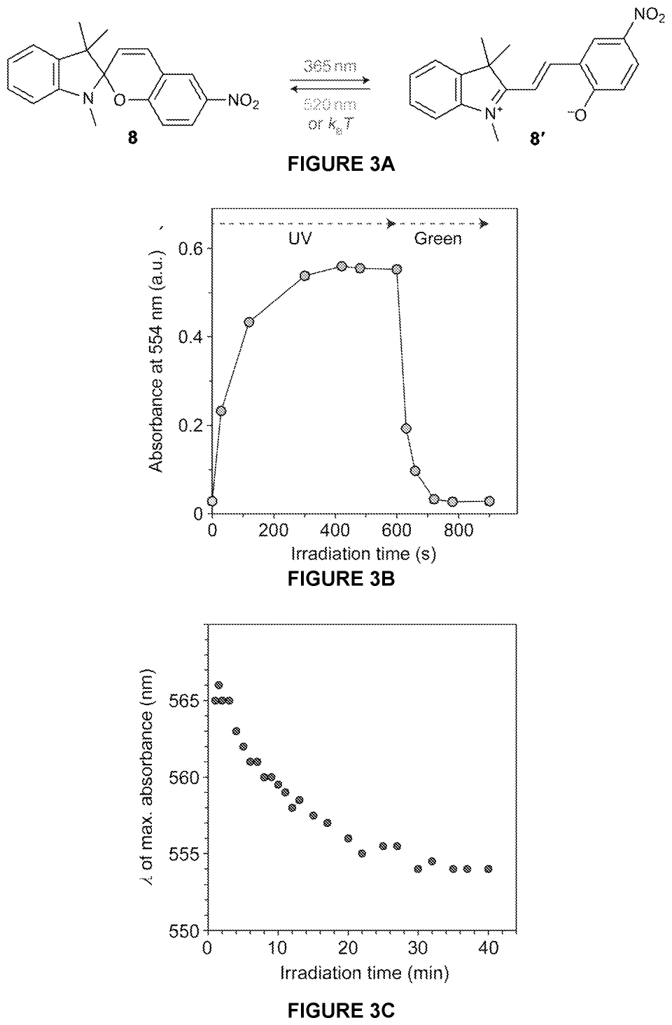

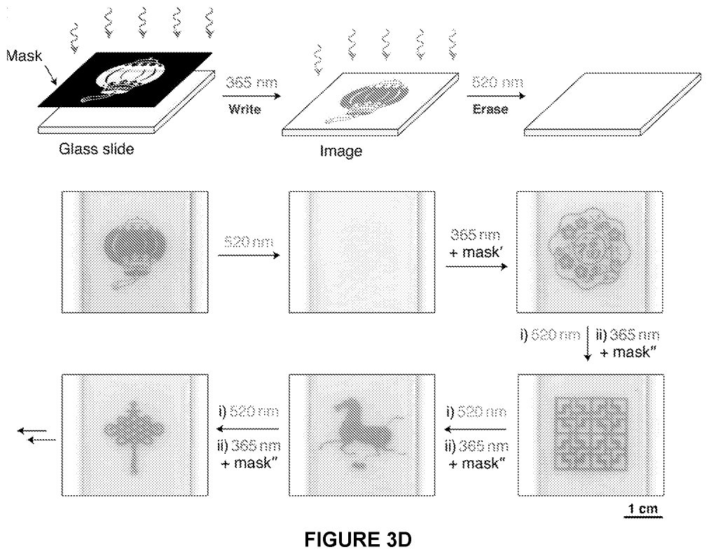

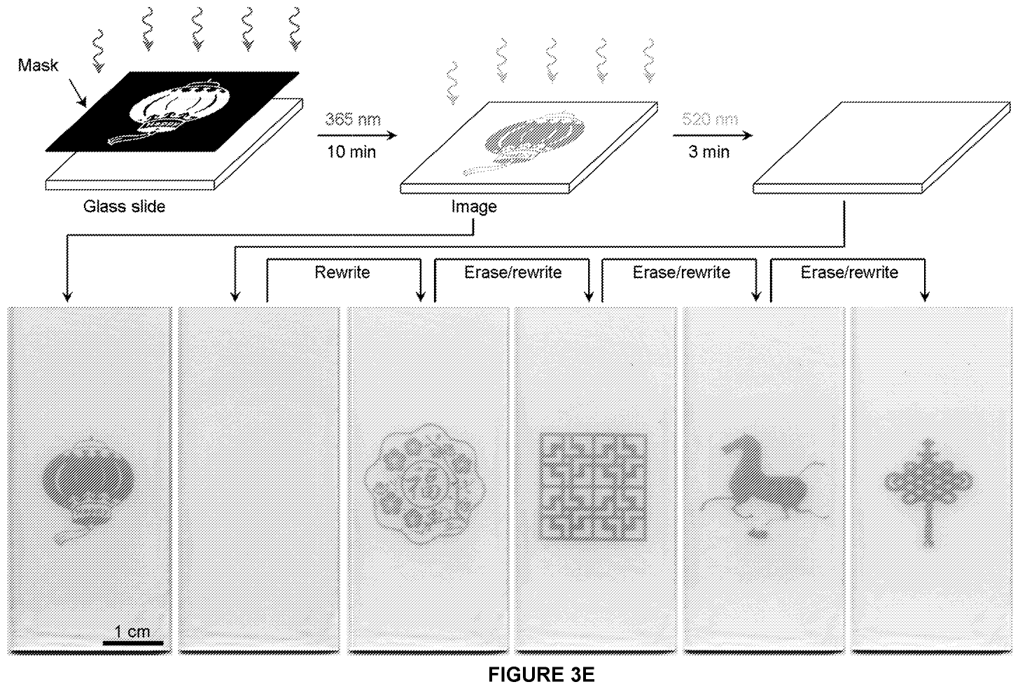

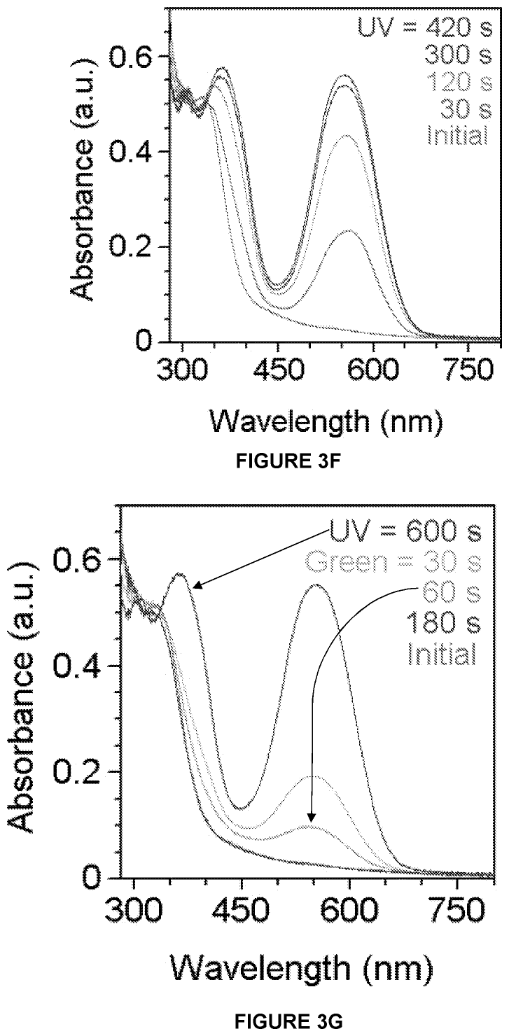

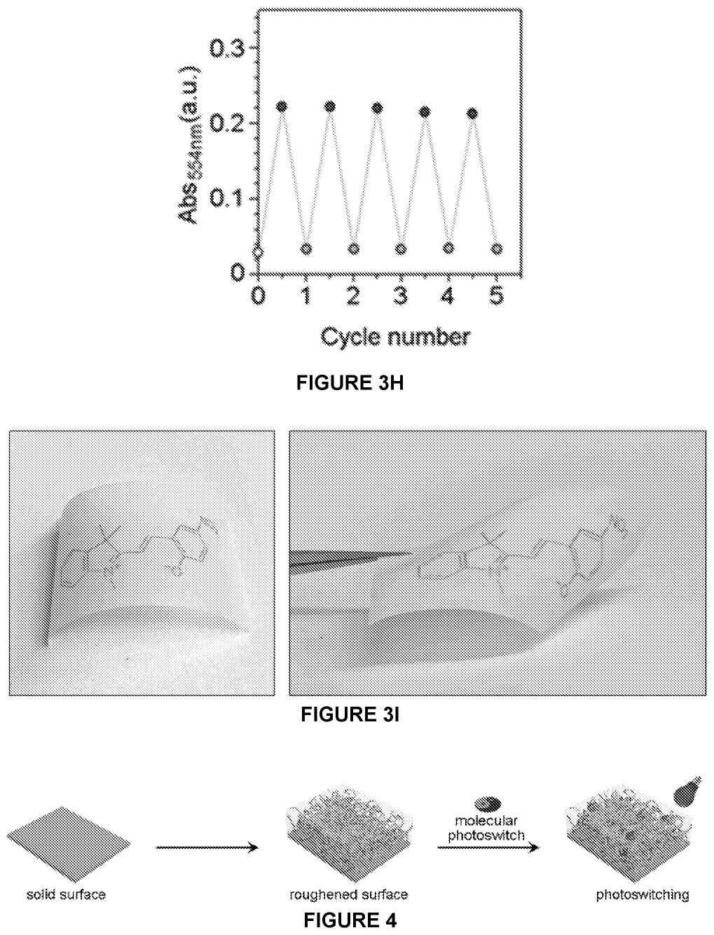

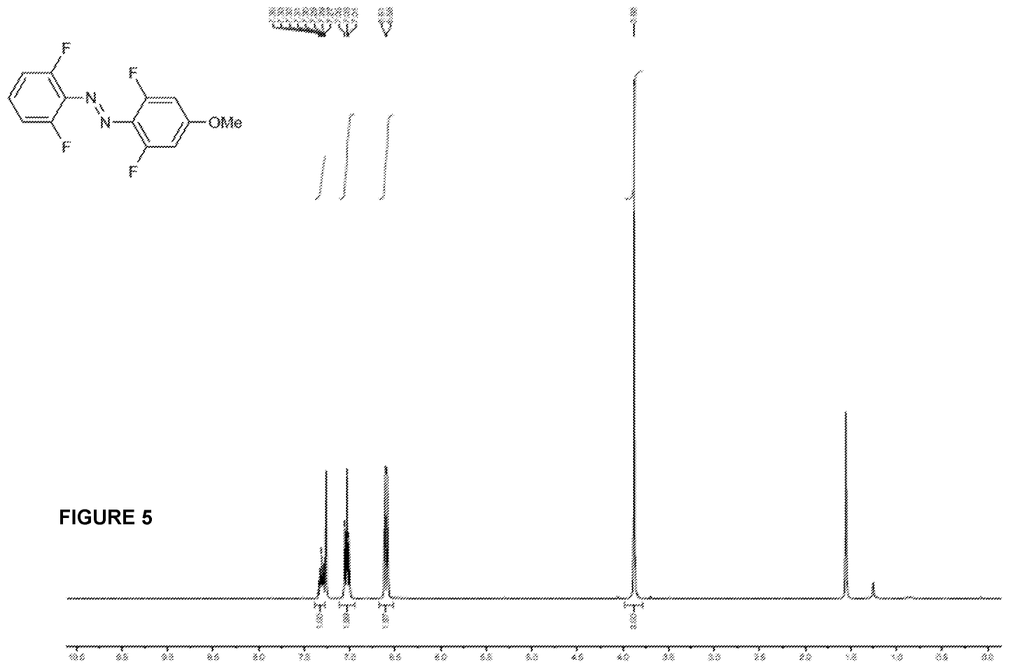

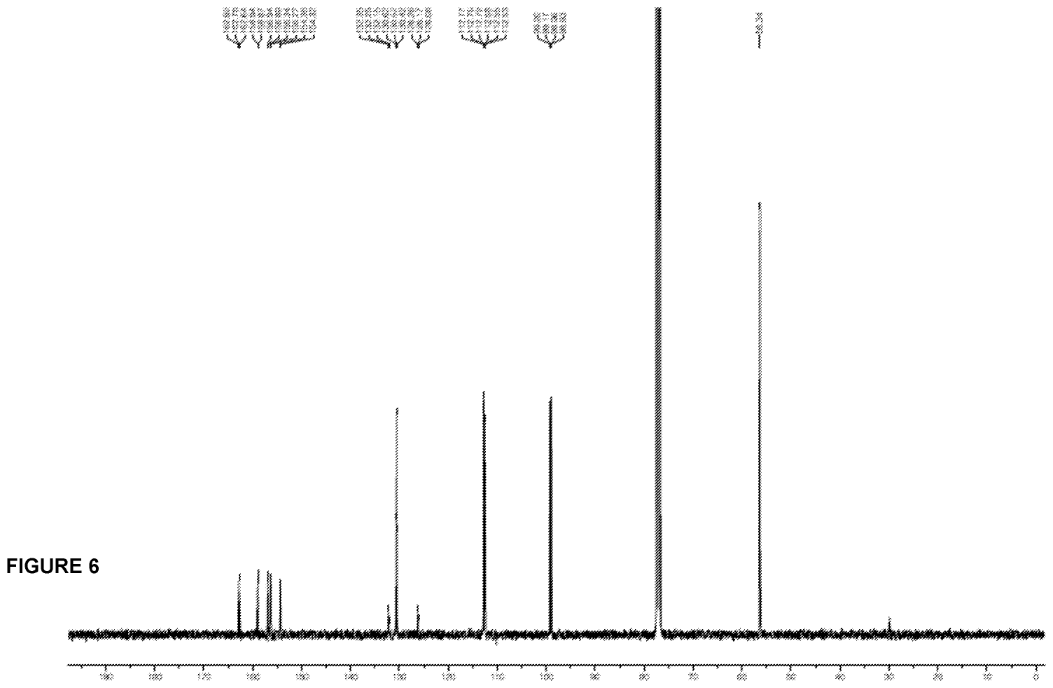

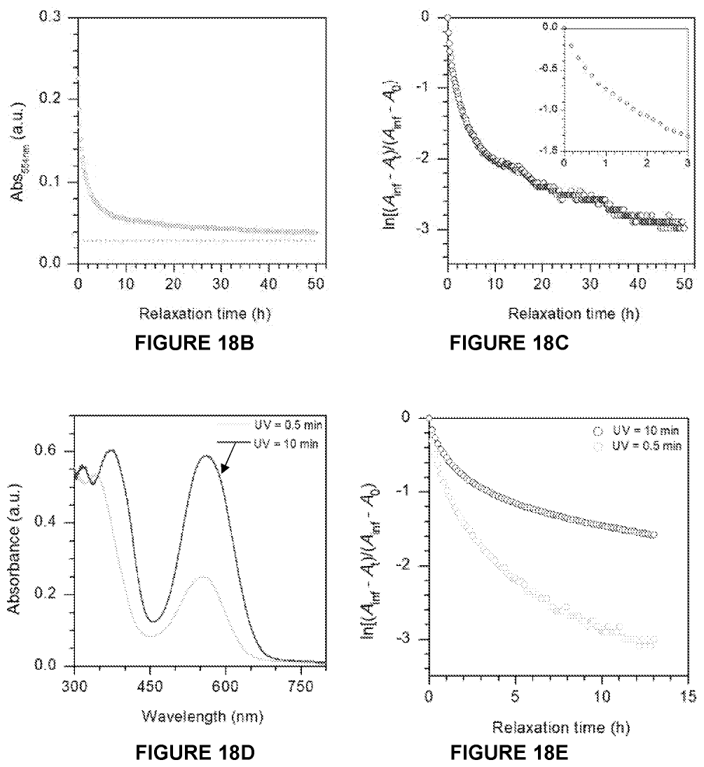

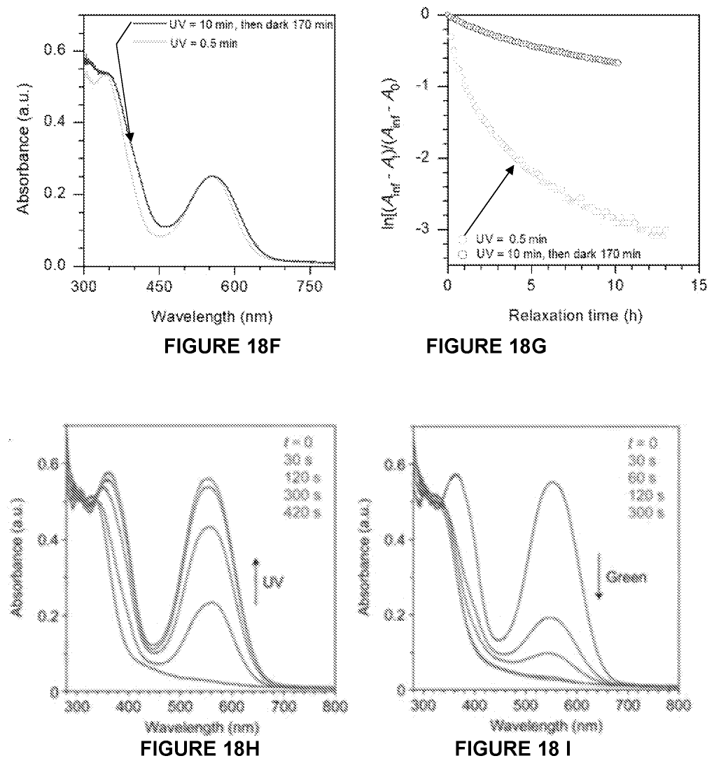

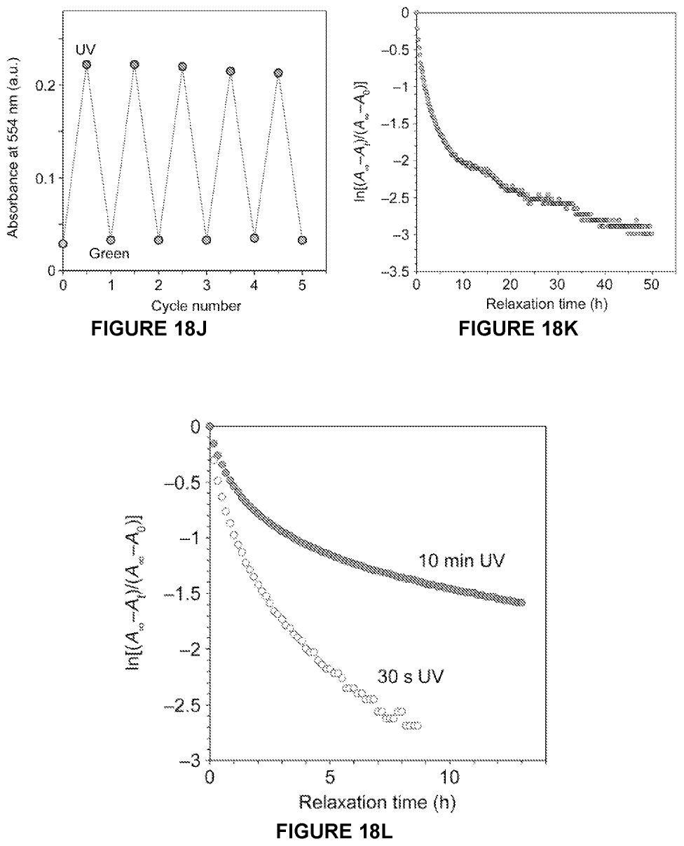

Finally, the polysiloxane nanofilament network-coated glass slides were used for the deposition of spiropyran (FIG. 3A). The closed-ring isomer of spiropyran shows strong absorbance in the near-UV region; however, UV irradiation results in a ring-opening reaction, and the appearance of an intense absorption band centered at 554 nm (FIG. 3B). Indeed, it was found that upon exposure to UV, the initially colorless glass slide became purple. Subsequent exposure of the glass slide rich in purple, ring-open isomers (merocyanine) to green (520 nm) light resulted in a fast back-isomerization reaction, regenerating the colorless, ring-closed isomer (FIGS. 3C and 3D). The application of these spiropyran-coated glass slides as a rewritable material was therefore considered. It was hypothesized that the exposure of these slides to UV through a mask could result in an image, which could be erased using visible light. Indeed, high-contrast, high-resolution images could be created efficiently using UV light of intensity as low as 0.1 mW/cm⁻² (FIG. 3G). Subsequent irradiation with green light was used to erase the image, and the cycle could be repeated at least five times (FIGS. 3D, 3F and 3H). Since the ring-closed form of spiropyran represents the thermodynamically stable state, decoloration could also be achieved by thermal relaxation in dark, although this took more than 24 hours to complete (FIG. 18B). This result is corroborated by the kinetics of thermal back-isomerization deviating from the first-order kinetics (see Example 7 herein below). This may exemplify a limitation of this platform in some embodiments.

In one embodiment and as discussed herein above, it was shown that transparent polysiloxane nanofilament structures created in situ on flat substrates could be used for dispersing molecular photoswitches. The amount of molecular photoswitches in the resulting network-coated substrates can be as much as two orders of magnitude higher than the amount of molecular photo switches within densely-packed molecular monolayers. The absorption of the deposited chromophores depended linearly on and could be predictably controlled by the concentration of the stock solution. Photoswitchable molecules dispersed within these networks could be isomerized efficiently and for many cycles. The concept demonstrated in this embodiment enables transferring of photoswitchability of molecular switches from solutions to surfaces.

Devices, Apparatuses and Systems of this Invention

In one embodiment, this invention provides a device comprising:
a substrate;
a porous structure layer attached to said substrate; and
organic molecules incorporated within said porous structure;
   wherein said organic molecules are photoswitchable such that when exposed to radiation of a certain wavelength, the structure of said molecules is changed.

In one embodiment, the porous structure comprises filaments. In one embodiment, the porous structure comprises filaments and has a surface area of between 10 m²/g and 10,000 m²/g. In one embodiment, the filaments are nanofilaments.

In one embodiment, the substrate material comprises a metal, a metal alloy, a metal oxide or any combination thereof. In one embodiment, the metal comprises aluminum. In one embodiment, the metal comprises iron. In one embodiment, the metal alloy comprises steel. In one embodiment, the metal oxide is selected from the group consisting of: silicon oxide, tin oxide, indium tin oxide, aluminum, steel, or any combination thereof. In one embodiment, the substrate material comprises a polymer. In one embodiment, the substrate material comprises an organic polymer. In one embodiment, the substrate is optically transparent in the visible light range, in the UV light range or in a combination thereof. In one embodiment, the substrate is optically transparent in portions of the visible light range, in portions of the UV light range or in a combination thereof. In one embodiment, the substrate is not transparent in the visible light range, in the UV range or in a combination thereof. In one embodiment, the substrate is rigid. In one embodiment, the substrate is flexible. According to this aspect and in one embodiment, the substrate can be curved, folded, wrapped around another material, cover a non-flat material, rolled, bent, twisted or any combination thereof. In one embodiment, the thickness of the flexible substrate ranges between 10 μm and 100 μm. In one embodiment, the thickness of the flexible substrate ranges between 1 μm and 1 cm. In one embodiment, the substrate comprises an organic material. In one embodiment, the substrate consists of an organic material. In one embodiment, the substrate comprises a polymer. In one embodiment, the polymer is an organic polymer. In one embodiment, the polymer is polypropylene. In one embodiment, the substrate comprises or consists of a polymer and the polymer comprises inorganic and organic groups. For example and in one embodiment, the polymer comprises silicon-oxygen backbone and organic groups covalently-bonded to the silicon-oxygen backbone.

In one embodiment, the porous structure comprises polysiloxane. In one embodiment, the porous structure consists of polysiloxane. In one embodiment, the porous structure consists of or comprises a material selected from polysiloxanes. In one embodiment, the polysiloxane is derived from (or produced from) trichloromethylsilane or other silanes. In one embodiment, the porous structure is optically transparent in the visible light range, in the UV light range or in the combination thereof. In one embodiment, the porous structure comprises organic and inorganic materials. In one embodiment, the porous structure comprises or consists of inorganic materials. In one embodiment, the porous structure does not comprise organic materials. This embodiment refers to the porous structure itself, prior to incorporating the photoswitches in it. In one embodiment, the porous structure comprises organic materials. In one embodiment, the porous structure comprises a silicon-oxygen backbone and organic materials. In one embodiment, the porous structure comprises a silicon-oxygen backbone and alkyl side groups covalently bonded to silicon atoms in the backbone.

In one embodiment, the pores in said structure are micropores, nanopores or a combination thereof. In one embodiment, the porous structure is hydrophobic. In one embodiment, the porous structure is superhydrophobic.

In one embodiment, the porous structure comprises filaments. In one embodiment, the porous structure comprises a porous network of said filaments. In one embodiment, the porous network of filaments comprises polysiloxane filaments. In one embodiment, the porous network is a porous network of polysiloxane nanofilaments. According to this aspect and in one embodiment, the filaments are entangled. In one embodiment, the network is an irregular structure of entangled filaments, and the network is porous.

In one embodiment, the cross section or diameter of the filaments is in the nanometer range. In one embodiment, the cross section or the diameter of the filaments ranges between 10 nm and 500 nm. In one embodiment, the cross section or the diameter of the filaments ranges between 10 nm and 1000 nm or between 10 nm and 200 nm, or between 10 nm and 150 nm. In one embodiment, the length of the filaments or portion thereof is at least 1 micron. In one embodiment, the length of the filaments or portion thereof is at least 2 microns (μm) or at least 500 nm or at least 10 microns.

In one embodiment, the thickness of the porous structure layer on a substrate ranges between 10 nm and 1 mm. In one embodiment, the thickness of said porous structure ranges between 0.5 μm and 10 μm. In one embodiment, the thickness of the porous structure is in the nm range, or in the micrometer range, or in the mm range or in the cm range. In one embodiment, the thickness range is 1 μm to 2 μm, 1 μm to 100 μm, 1 μm to 1000 μm, 1 μm to 10 mm, 100 nm to 1 μm, 100 nm to 10 μm, or 100 nm to 100 μm.

In one embodiment, the pores in the porous structure are of asymmetric shape. In one embodiment, the pores in the porous structure or a portion thereof are connected such that material can be transferred through the pores and can be transferred between pores, see for example FIG. 1B. According to this aspect and in one embodiment, the porous structure comprises a continuous structure of filaments comprising a continuous empty area throughout the structure, the empty area reflects the porosity of the structure.

In one embodiment, the organic molecules are selected from the group consisting of: azo compounds, spiropyrans or any combination thereof. In one embodiment, the azo compound is a compound of formula 1:

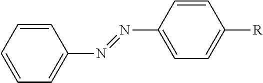

wherein R is OCH₃ (A1) or OCH₂C₂H₃ (A2) or O(CH₂CH₂O)₆(CH₂)₃SCOCH₃ (A3) or O(CH₂)₁₁SCOCH₃ (A7) or O(CH₂CH₂O)₃(CH₂)₃SCOCH₃ (A8).

In one embodiment, the azo compounds comprise compounds of formula 2:

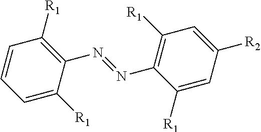

wherein R₁ is OCH₃ and R₂ is H (A4) or wherein R₁ is F and R₂ is OCH₃ (A5).

In one embodiment, the azo compounds comprise compounds of formula 3 (A6):

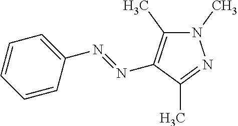 [SMILES: Cc1nn(C)c(C)c1/N=N/c1ccccc1]

In one embodiment, upon said structure change, the absorption spectra of said molecules changes. In one embodiment, upon structure change, the molecules switch from color-visible to transparent or from transparent to color-visible. In one embodiment, upon said structure change, the molecules switch from exhibiting one color to exhibiting a different color. In one embodiment, upon said structure change the molecules switch from exhibiting color with a certain intensity to exhibiting the same color with a different intensity.

In one embodiment, the structure change comprises transformation from a first isomer to a second isomer of said molecule. In one embodiment, the first isomer and the second isomer are stereoisomers. In one embodiment, the first isomer and the second isomer are structural isomers. In one embodiment, the isomers are cis-trans isomers. In one embodiment, the isomers are stereoisomers. In one embodiment, the isomers are configurational isomers. In one embodiment, the isomers are constitutional isomers. In one embodiment, the dimensions of the device parallel to the substrate surface comprise length and width ranging between 1 mm and 10 m, and the thickness of the device measured perpendicular to the substrate surface is ranging between 10 nm and 1 mm. In one embodiment, the thickness of the device measured perpendicular to the substrate surface is ranging between 10 nm and 1 cm or between 10 nm and 10 cm.

In one embodiment, the substrate is inorganic. In one embodiment, the porous structure comprises organic and inorganic materials. In one embodiment, the photochromic compounds are organic compounds. In other embodiments, the porous structure is inorganic.

In one embodiment, this invention provides smart window comprising the device as described herein, wherein the substrate is transparent in the visible-light range and wherein the lateral length and width of said window measured parallel to said substrate is ranging between 10 cm to 10 m. In some embodiment, these dimensions are applicable to other devices of this invention and are not restricted to smart windows.

In one embodiment, this invention provides an optical switch comprising:
the device as described herein, wherein the substrate is transparent in the visible-light range;
an irradiation source.

In one embodiment, this invention provides a memory device or an encoder comprising:
the device as described herein, wherein the substrate is transparent in the visible-light range;
an irradiation source;
an optical detector.

In one embodiment, the irradiation source comprises a lamp, a laser, natural light source (the sun), or a combination thereof. In one embodiment, the lamp is a light emitting diode (LED) lamp, a fluorescent lamp, an incandescent lamp, halogen lamp or any combination thereof. In one embodiment, the light source (irradiation source) provides light in the range of 200 nm to 400 nm or in the range of 400 nm to 800 nm or any combination thereof. In one embodiment, the light source provides certain wavelengths, including but not limited to 365 nm, 420 nm, 460 nm, 520 nm, 632 nm. In some embodiments, the light source illuminates the device with a certain wavelength or with a range of wavelengths including a certain wavelength. In one embodiment, any description provided herein above for a first light source is applicable to a second light source. In one embodiment, any description provided herein for illuminating/irradiating of a first wavelength is applicable to a step of illuminating/irradiating with a second wavelength.

In one embodiment, the optical detector comprises any optical detector known in the art. In one embodiment, the optical detector is or comprises a camera. In one embodiment, the optical detector is tuned for detecting a certain wavelength or a certain wavelength range.

In one embodiment, smart windows, optical switches, memory devices, encoders and any other device of this invention further comprise optical elements such as filters, lenses, gratings, etc.

In one embodiment, devices, apparatuses and systems of this invention further comprise a computer, a display, electronic components, calculation algorithms etc. In one embodiment, devices, apparatuses and systems of this invention are operated manually or automatically, or using a combination of manual and automatic operation.

Illustrations of embodiments of devices, systems and apparatuses is shown in FIG. 30, wherein element 1 is or comprises the device comprising a substrate, porous materials and organic molecules within the porous material. Element 2 is an irradiation source, element 3 is a detector that can be placed on the side opposing the device 1 (FIG. 30B) or on the same side as the irradiation source (FIG. 30C) for non-transparent or partially transparent substrates. Elements 4, 5 and 6 describe additional optional elements such as gauges, monitors, electronic components, optical components, mechanical components, optical fibers, wires and connectors, computer, processor, display, touch-screen, other user interfaces, knobs, switches etc. as described herein above and as known in the art. The configuration of the elements in the figure is an example. Other orientations, different distribution, various relative location of the elements and different scales are included in this invention. The presence of elements 2, 3, 4, 5, and 6 or any combination thereof is optional. In some embodiment, the only element in devices of this invention is element 1 in FIG. 30.

Additional properties of devices and apparatuses of this invention are described in further detail in the device preparation section herein below.

In one embodiment, this invention provides a material comprising:
a powder comprising porous particles; and
organic molecules incorporated within said porous particles;
   wherein said organic molecules are photoswitchable such that when exposed to radiation of a certain wavelength, the structure of said molecules is changed.

In one embodiment, the porous particles comprise polysiloxane. In one embodiment, the porous particles consist of polysiloxane. In one embodiment, the surface area of the powder ranges between 150 m²/g and 300 m²/g. In one embodiment, the surface area of the particles ranges between 150 m²/g and 300 m²/g. In one embodiment, the surface area of the powder or of the particles or of the particles and the powder is higher than 200 m²/g. In one embodiment, the surface area of the particles or of the powder ranges between 50 m²/g and 500 m²/g, or between 10 m²/g and 5000 m²/g, or between 100 m²/g and 1000 m²/g, or between 500 m²/g and 10,000 m²/g, or between 10 m²/g and 10,000 m²/g. Surface area described herein is measured by BET in one embodiment. In one embodiment, the surface area and other embodiments described herein above for porous particles or powder are also applicable to the porous layer (the porous structure) on substrates, as described in devices of this invention. In one embodiment, all the embodiments described herein for the organic molecules incorporated within a porous structure layer attached to a substrate, are also applicable to organic molecules incorporated within the porous particles of the powder in materials of this invention.

In one embodiment, the photochromes incorporated within the porous structure can change structure from one isomer to another. In one embodiment, this change is induced by light of a certain wavelength. In one embodiment, the absorption spectrum of the device in the UV, visible or the UV and visible range is different for the two isomers. According to this aspect and in one embodiment, the absorption of the main peak of the UV-vis absorption spectrum of a device comprising one isomer is at least 2 times the absorption of the same peak of the same device when comprising predominantly the second isomer. In one embodiment, when one isomer is converted to another in devices of this invention, the absorption of the main peak in the UV-vis spectrum is changed by at least 50%. In one embodiment, in devices of this invention, the main peak in the UV-vis absorption spectrum of a device comprising a first isomer, is absent in the UV-vis absorption spectrum of the same device when comprising the second isomer. In some embodiments, the two isomers are isomers of the same compound. In one embodiment, the conversion of one isomer to another causes a shift in the wavelength of the main peak in the spectrum of the device. In one embodiment, in devices of this invention, the wavelength of the main peak in the UV-vis absorption spectrum of a device comprising a first isomer, is at least 10 nm or at least 20 nm or at least 30 nm or at least 50 nm apart from the wavelength of the main peak in the UV-vis absorption spectrum of the same device when comprising the second isomer. In one embodiment, the wavelength of the main peak as described herein above is the wavelength of maximum absorption. The conversion of one isomer to another is not 100% in one embodiment. The embodiments described herein are applicable to the two states of the device, in the first state the device comprising more than 50% of a first isomer, and in the second state, the same device comprising more than 50% of the second isomer.

In one embodiment, the organic molecules within the porous layer are not covalently bonded to the porous layer. In another embodiment, the organic molecules within the porous layer are covalently bonded to the porous layer. In one embodiment, a portion of the organic molecules within the porous layer is covalently boded to the porous layer.

Methods of Producing

In one embodiment, this invention provides a method of preparation of a photochromic device, said method comprising:
providing a substrate;
producing porous layer on said substrate;
depositing photochromic compounds into said porous layer.

In one embodiment, the porous structure comprises filaments. In one embodiment, the porous layer comprises filaments and has a surface area of between 10 m²/g and 10,000 m²/g. In one embodiment, the filaments are nanofilaments.

In one embodiment, the substrate comprises SiO₂. In one embodiment, the substrate comprises silicon and oxygen atoms.

In one embodiment, the porous layer comprising polysiloxane nanofilaments. In one embodiment, the producing step comprises vapor deposition of a chemical precursor on said substrate. In one embodiment, the producing step comprises dip coating of a chemical precursor from liquid solution onto said substrate. In one embodiment, the chemical precursor is trichloromethylsilane. Other possible precursors comprise or consist of other trichloroalkylsilanes (such as trichloroethylsilane). Any chlorosilanes containing one or more than one alkyl group, as well as other halosilanes precursors are used in embodiments of this invention. Silanes comprising one or two alkyl groups and two or three halogen groups are included as chemical precursors for a porous layer of this invention. In one embodiment, the solvent of said chemical precursor solution comprises toluene. In one embodiment, the solvent of said chemical precursor solution comprises DMSO. In one embodiment, the solvent of said chemical precursor solution comprises THF, acetonitrile, benzene, hexane or any combination thereof. Other solvents in which the chemical precursor is dissolved are included in embodiments of this invention. In other embodiments, the vapor for vapor deposition is formed from a molecular liquid/gas or from a different solution suitable for vapor deposition. In one embodiment, the precursor for the polysiloxane nanofilaments is trichloromethylsilane. In one embodiment, the trichloromethylsilane concentration in the solution used for production of the porous layer is (0.3% v/v). In one embodiment, the production of the porous layer is conducted in air. In one embodiment, the production of the porous layer is conducted in air with relative humidity of ˜35%. In one embodiment, producing the porous layer on the substrate comprise dipping the substrate in a solution comprising a precursor of the porous layer material (such as trichloromethylsilane) for 0.5 h. In some embodiments, following dipping in the precursor solution, the substrate is removed from the solution, washed with solvent(s) and dried. Other production conditions such as different gases used or present in the vapor deposition step, various humidity %, various pressures, production time and temperatures and various washing and drying methods are applicable to embodiments of this invention as known in the art.

In one embodiment, the photochromic compounds are deposited from a liquid solution, and the solvent of said liquid solution is toluene. In one embodiment, the solvent of the solution comprising the organic photochromic molecules comprises DMSO. In one embodiment, the solvent comprising the photochromic molecules comprises THF, acetonitrile, benzene, hexane or any combination thereof. Other solvents in which the photochromic molecules are dissolved are included in embodiments of this invention. In one embodiment, the step of depositing the organic molecules into the porous structure is conducted by immersing or dipping the substrate with the porous layer in a solution comprising the organic molecules. Following immersion, the substrate comprising the porous layer now incorporating organic molecules is removed from the solution of the organic molecules. In some embodiments, the removed substrate is dried. In some embodiments the removed substrate is not washed but only dried. In some embodiments, the dipping (immersion) times of the substrate with the porous layer in the solution of organic molecules is 1 s. In one embodiment, dipping time ranges between 0.1 s and 2 s. In one embodiment, dipping time ranges between 0.1 s and 10 s. In one embodiment, dipping time is at least 0.5 s. In one embodiment, dipping time is at least 1 s. In one embodiment, dipping time ranges between 0.1 s and 1 min. In one embodiment, the photochromic compounds are deposited from vapor, and the vapor phase is formed from a liquid solution as described herein above. In other embodiments, the vapor is formed from a molecular liquid/gas or from a different solution suitable for vapor deposition. In one embodiment, the concentration of the photochromic molecules in the solution used for depositing or in a solution used for vapor phase generation is 12 mM, 1.7 mM, 38.2 mM. In one embodiment, the concentration of the photochromic molecules in the solution used for depositing or in a solution used for vapor phase generation is ranging between 1.7 mM to 38.2 mM, or between 1 mM and 12 mM, or between 1 mM and 100 mM, or between 0.1 mM and 100 mM, or between 1 mM and 10 mM, or between 10 mM and 40 mM, or between 0.01 mM and 10 mM, or between 0.001 mM and 500 mM.

In one embodiment, the step of depositing photochromic compounds onto/into said porous layer results in the incorporation of the photochromic compounds within the porous layer. In one embodiment, depositing photochromic compounds onto said porous layer refers to incorporating photochromic compounds into the porous layer. By depositing the photochromic compounds onto the porous layer, the compounds penetrate into the pores or into the voids or vacancies within the porous layer and become incorporated within the porous layer. In one embodiment, the step of depositing photochromic compounds onto said porous layer results in deposition of the photochromic compounds within the porous structure. According to this aspect and in one embodiment, this invention provides a method of preparation of a photochromic device, said method comprising:
providing a substrate;
producing porous layer on said substrate;
incorporating a photochromic compound within the porous layer.

In one embodiment, the photochromic compound is incorporated within the porous layer, and is also present on top of the porous layer. In one embodiment, the photochromic compound is incorporated within the porous layer, and is not present on top of the porous layer.

In one embodiment, the porous layer is first produced on the substrate, and only after this step, the organic molecules are incorporated into the porous layer. In one embodiment, the organic molecules are incorporated into the porous layer from a liquid solution. In one embodiment, in the liquid solution the organic molecules are the solute, and the solvent is an organic solvent or a combination of two or more solvents. In one embodiment, the organic molecules are incorporated into the porous layer from gas. In one embodiment, the organic molecules are incorporated from a liquid comprising the molecules, or from a liquid consisting of the molecules.

In one embodiment, the organic molecules (the photochromic materials) are incorporated within the pores/voids/vacancies between the filaments that make up the porous material. According to this aspect and in one embodiment, the organic molecules are not present within the filaments. The organic molecules are only present in the spaces surrounding the filaments in one embodiment. In one embodiment, the filaments of the porous structure do not comprise photochromic compounds/materials. According to this aspect and in one embodiment, the filaments are a matrix and the organic molecules are present in the spaces of the matrix. In another embodiment, the organic molecules are present within the filaments. The description herein above with regards to filaments is also applicable to a porous structure that does not comprise filaments, a non-filament porous structure such as for example a non-filament sponge-like structure.

In one embodiment, this invention provides a method of preparation of a photochromic device, said method comprising:
providing a substrate;
producing porous layer on said substrate, said porous layer comprises photochromic compounds.

According to this aspect and in one embodiment, the application of the porous layer and the application of the photochromic molecules to the substrate are performed in one step. According to this aspect and in one embodiment, a solution comprising a porous layer precursor and photochromic molecules is prepared. The solvent of this solution can be any solvent, for example toluene. The production of the porous layer comprising the molecules is performed from the liquid solution in one embodiment or from a vapor phase in another embodiment.

In one embodiment, the substrate is dipped into a liquid solution comprising the porous structure precursor and the organic photochromic molecules. After a period of time (e.g. ranging from 1 min to 24 h) the substrate is taken out of the liquid. A layer of porous structure comprising the photochromic molecules is now present on the substrate.

In one embodiment, the substrate is placed in a chamber and/or is fixed to a holder. The liquid solution comprising the porous structure precursor and the organic photochromic molecules is allowed to evaporate (under any appropriate temperature/pressure conditions). After a period of time (e.g. ranging from 1 min to 24 h) the substrate is transferred away from the vapor atmosphere. A layer of porous structure comprising the photochromic molecules is now present on the substrate.

In some embodiments, depending on the porous structure material, other application methods can be used to form the porous layer on the substrate, these methods include but are not limited to spray coating, spin-coating, electrochemistry, micro- and nano-fabrication techniques including lithography, mold and template-based methods etc., powder processing, sintering or a combination thereof. In some embodiment, two-component materials are utilized in forming a porous structure for devices of this invention. According to this aspect and in one embodiment, such two-component materials include but are not limited to block copolymers, organic-inorganic composites, metal alloys or any combination thereof. According to this aspect and in one embodiment, the two-component material is first deposited on the substrate. An extraction or removal step of one of the two components is then conducted, thus resulting in a porous material. The removal of one component is usually performed chemically, using a chemical that affects removal of one component but does not affect removal of the other component.

In one embodiment, the density or surface concentration of the photochromic compounds within (or in and on) the porous structure is higher than 10 nmol·cm⁻². In one embodiment, the density of the photochromic compounds in the porous structure is 18.2 nmol·cm⁻² or 18.8 nmol·cm⁻² or 21.7 nmol·cm⁻² or 23.8 nmol·cm⁻² or 60.3 nmol·cm⁻². In one embodiment, the density of the photochromic compounds in the porous structure is ranging between 18.8 nmol·cm⁻² to 23.8 nmol·cm⁻². In one embodiment, the density of the photochromic compounds in the porous structure is ranging between 1 nmol·cm⁻² to 100 nmol·cm⁻², or between 1 nmol·cm⁻² to 1000 nmol·cm⁻², or between 10 nmol·cm⁻² to 100 nmol·cm⁻², or between 0.1 nmol·cm⁻² to 1 μnmol·cm⁻², or between 10 nmol·cm⁻² to 500 nmol·cm⁻², or between 0.01 nmol·cm⁻² to 1 nmol·cm⁻². In one embodiment, the density of the photochromic compounds in the porous structure is at least 1 nmol·cm⁻², or at least 2 nmol·cm⁻² or at least 10 nmol·cm⁻². Higher density values and ranges are possible for thicker layers of porous structures and/or for structure with higher porosity as known to the skilled artisan.

In one embodiment, this invention provides a method of preparation of a photochromic material, the method comprising:
producing porous particles in a solvent;
depositing photochromic compound(s) into said porous particles.

In one embodiment, the step of depositing photochromic compounds into the porous particles comprise introducing photochromic compound(s) into the solvent comprising the porous particles. In one embodiment, the photochromic compounds are dissolved in a solvent to form a solution and this solution is mixed with the solvent that comprises the porous particles. In one embodiment, a solvent (e.g. toluene) is provided, and the starting material for the porous particles (e.g. methyl-trichloro-silane) and the photochromic compound(s) are both introduced into it (in parallel or sequentially), thus forming the porous particles comprising the photochromic compound(s). In one embodiment, after drying, the resultant product is in the form of a powder. In one embodiment, all the embodiments described herein for methods of producing organic molecules incorporated within a porous structure layer attached to a substrate, are also applicable to methods of producing organic molecules incorporated within porous particles in materials of this invention. In one embodiment, ultrasound is used for suspending the porous particles in a liquid, or for mixing the photochromic materials and the porous particles in a liquid, or for a combination thereof

Uses

In one embodiment, this invention provides a method of changing an initial color of a device, said method comprising:
providing a device comprising:
   a substrate;
   a porous structure attached to said substrate; and
   organic molecules incorporated within said porous structure;
      wherein said organic molecules are photoswitchable such that when exposed to radiation of a certain wavelength, the structure of said molecules is changed;
irradiating said device with light of a first wavelength, thus inducing molecular structural or conformation or configuration change; thereby changing the color of said device.

In one embodiment, the molecular structural or conformation or configuration change, results in a change of the absorption spectra of said organic molecules. The molecular structural or conformation or configuration change refers to the organic molecules in one embodiment.

In one embodiment, the color change comprising change of absorption spectra of the organic molecules. In one embodiment, the photochromes (organic molecules) incorporated within the porous structure change structure from one isomer to another. In one embodiment, this change is induced by light of a certain wavelength. In one embodiment, the absorption spectrum of the device in the UV, in the visible, or the UV and visible range is different for the two isomers. According to this aspect and in one embodiment, the absorption of the main peak of the UV-vis absorption spectrum of a device comprising one isomer is at least 2 times the absorption of the same peak of the same device when comprising predominantly the second isomer. In one embodiment, when one isomer is converted to another in devices of this invention, the absorption of the main peak in the UV-vis spectrum is changed by at least 50%. This property is used for various applications of the device as described herein. In one embodiment, in devices of this invention, the main peak in the UV-vis absorption spectrum of a device comprising a first isomer, is absent in the UV-vis absorption spectrum of the same device when comprising the second isomer. In some embodiments, the two isomers are isomers of the same compound. In one embodiment, the conversion of one isomer to another causes a shift in the wavelength of the main peak in the spectrum of the device. In one embodiment, in devices of this invention, the wavelength of the main peak in the UV-vis absorption spectrum of a device comprising a first isomer, is at least 10 nm or at least 20 nm or at least 30 nm or at least 50 nm apart from the wavelength of the main peak in the UV-vis absorption spectrum of the same device when comprising the second isomer. The conversion of one isomer to another is not 100% in one embodiment. The embodiments described herein are applicable in one embodiment to the two states of the device, such that in the first state the device comprising more than 50% of a first isomer, and in the second state, the same device comprising more than 50% of the second isomer.

In one embodiment, the substrate is transparent. In one embodiment, the irradiating wavelength is in the UV or in the visible range. In one embodiment, the irradiating wavelength is in the UV and in the visible range. In one embodiment, the color change is reversible.

In one embodiment, the porous structure comprises filaments. In one embodiment, the porous structure comprises filaments and has a surface area of between 10 m²/g and 10,000 m²/g.

In one embodiment, the method further comprising irradiating said device with light of a second wavelength, thus changing the color of said device back to said initial color.

In one embodiment, after irradiating said device with light of a first wavelength, the device is kept for a period of time without being irradiated until the color of said device changes back to said initial color. In one embodiment, this changing back is spontaneous.

In one embodiment, the step of irradiating said device with light of a first wavelength is conducted for a period of time ranging between 1 sec and 1 h, or between 10 sec and 60 sec, or between 1 min and 10 min, or between 10 sec and 20 min or between 1 ms and 20 min. In one embodiment, the step of irradiating said device with light of a first wavelength is conducted using light intensity ranging between 1 μW·cm⁻² to 10 μW·cm⁻², or between 0.1 μW·cm⁻² to 100 μW·cm⁻², or between 1 μW·cm⁻² to 1 mW·cm⁻², or between 1 μW·cm⁻² to 10 mW·cm⁻², or between 0.01 μW·cm⁻² to 100 mW·cm⁻², or between 0.1 μW·cm⁻² to 1 mW·cm⁻². In one embodiment, the light intensity is 0.7 μW·cm⁻² or 1 μW·cm⁻² or 6 μW·cm⁻².

Any other exposure time/light intensity and combinations thereof can be used for various applications and uses of this method. Exposure time/light intensity depends on the photochromic material used in some embodiments.

### Definitions

Molecular photoswitches are molecules or chemical compounds that undergo a reversible change in their chemical structures when exposed (or following exposure) to electro-magnetic radiation, such as light. Properties that can be affected by exposure to light include but are not limited to structural or conformational or configurational change, cis-trans change, chemical composition change, chemical reaction, change of light absorption spectrum, change of electrochemical state, color change, or a combination thereof. For certain optical-related applications, the change of absorption spectrum of the compound (that results from conformational change or configurational change or molecular structure change or cis-trans isomerization change) is utilized. In such applications the absorption spectrum of the device comprising the molecules/compounds switches between two or more states. For some molecules/devices, this switching is reversible. Reversing the optical state or optical property of the device/compound is performed in some embodiments by irradiating/illuminating with light of a certain wavelength. Reversing the optical state or optical property of the device/compound is performed in some embodiments by allowing the device/compound to change its structure/conformation by thermal processes. According to this aspect and in one embodiment, leaving the device/compound in the dark (or under exposure to a certain wavelength or to a certain wavelength spectrum) for a certain period of time causes this change and the reversal of the compound/device to the initial or to a different optical state.

Photoswitches are sometimes refer to as molecular switches or molecular photoswitches, or as photoswitchable materials/compounds. Molecular switches usually comprise a chromophore, the chromophore is the element that absorb light of a certain wavelength or a certain wavelength range. In embodiments, photochromic materials or photochromic compounds or photochromes refer to photoswitches or to molecular photoswitches.

Superhydrophobic is a term used to describe extremely hydrophobic surfaces or materials. Super hydrophobic is defined as a surface wherein when a water drop is placed on that surface, the contact angle measured for this water drop on the surface is larger than 150°.

In one embodiment, ‘transparent’ means transparent in the visible range. In other embodiments, ‘transparent’ means transparent to other wavelength ranges. In some embodiments, transparent means that light of a certain wavelength (visible or non-visible) is transferred through said material.

Filament is an elongated structure, a thread, a thread-like structure, a hair-like structure, a fiber, a wire. In one embodiment, nanofilaments are filaments with a diameter or a cross section in the nm range.

In one embodiment, the porous material/the porous structure layer comprises or consists of polysilsesquioxane. For example: polysilsesquioxane nanowire networks (PNNs). The term polysilsesquioxane is interchangeable with polysiloxane, (for example: ‘polysiloxane nanofilament network layer’). Polysilsesquioxane and polysiloxane are different names for the same material(s) in some embodiments. In other embodiments, polysiloxanes with different structures or compositions are used as the porous structure/porous layer. Such polysiloxanes are included in embodiments of this invention.

In some embodiments, for simplicity, photochromic switches are referred to as ‘organic molecules’.

In embodiments, the terms organosilicon, polysiloxane, silicones are interchangeable and are used to define a material comprising a chemical backbone comprising silicon and oxygen atoms, wherein organic groups are bonded to at least a portion of the Si atoms.

In one embodiment, “roughened by” refers to the step of producing porous layer on said substrate. In one embodiment, “roughened by” refers to a substrate on which a porous layer is present. In one embodiment, “roughened by” means covered by or coated by. In one embodiment, “roughened by” means being roughed by or roughened as a result of application of a rough material as described and as shown in Figures herein. In one embodiment, roughened is referred to as ‘derivatized’ or ‘derivatized by’.

In one embodiment, ‘blue-adapted’ means exposed to blue light until there are no more changes. Similarly, ‘UV-adapted’ or any other ‘color-adapted’ are defined. When this situation of no more changes is reached, this is called a photostationary state (PSS). In one embodiment, no more changes mean no more spectral changes or no more color changes. For example, ‘UV-adapted’ means kept under UV light until an equilibrium is reached.

‘Porous structure layer’ is referred to also as ‘porous layer’ in some embodiments.

In some embodiments, deposition of organic molecules onto a porous layer results in incorporation of the organic molecules in or into the porous layer. Accordingly, deposition onto/into the porous layer means incorporation of the organic molecules in/within the porous layer in some embodiments.

In some embodiments, conformational change is also referred to as configurational change and vice versa. In one embodiment, cis-trans isomerization is considered a configurational change. When referring to “the structure of the molecules is changed” it is to be understood that the structure change is a general term including configurational changes, and conformational changes and any other isomerization change.

In one embodiment, the term “a” or “one” or “an” refers to at least one. In one embodiment the phrase “two or more” may be of any denomination, which will suit a particular purpose. In one embodiment, “about” or “approximately” may comprise a deviance from the indicated term of +1%, or in some embodiments, −1%, or in some embodiments, ±2.5%, or in some embodiments, ±5%, or in some embodiments, ±7.5%, or in some embodiments, ±10%, or in some embodiments, ±15%, or in some embodiments, ±20%, or in some embodiments, ±25%.

The time unit second is sometimes written as ‘sec’ or as ‘s’. ‘msec’ and refer to millisecond in one embodiment.

(SNFs) are silicone nanofilaments. In some embodiments, the porous structure comprises or consist of SNFs. PSS is photostationary state. polysilsesquioxane nanowire networks (PNNs). In one embodiment, ‘freestanding PNNs’, are PNNs not attached to any solid substrate. In one embodiment, ‘freestanding PNNs’, are PNNs not attached as a layer to any solid substrate. In one embodiment, ‘freestanding PNNs’, are PNNs not attached during their formation to a solid substrate. In one embodiment, the powder of PNN particles or the particles are ‘free standing’. In one embodiment, the freestanding powder/particles can be later attached to or placed on a substrate.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

### EXAMPLES

### Example 1

### Materials and Methods

All chemicals were of analytical grade and were used as received. ¹H and ¹³C NMR spectra were recorded on a Bruker Avance III 400 MHz or a Bruker Avance III HD 500 MHz NMR spectrometer. Chemical shifts (δ) in the ¹H NMR spectra are reported in parts per million (ppm) relative to residual solvent resonances (2.50 ppm for (CD₃)₂SO or 7.26 ppm for CDCl₃). Multiplicities in the ¹H NMR spectra are reported as s (singlet), d (doublet), t (triplet), and m (multiplet). Chemical shifts (δ) in the ¹³C NMR spectra are reported in ppm relative to TMS relative to residual solvent resonances (77.16 ppm for CDCl₃). Electrospray ionization mass spectrometry (ESI-MS) measurements were carried out on a Waters Micromass Q-TOF spectrometer. Scanning electron microscopy (SEM) was done on a Zeiss Ultra 55 microscopy. UV/Vis absorption spectra were recorded with a Shimadzu UV-2700 spectrophotometer. To facilitate the UV/Vis analysis of the adsorbed molecules, polysiloxane nanofilament network-coated glass slide (before adsorbing photoswitches) were always used as the baseline. For photoirradiation experiments, the following sources were used: a 365 nm UVP UVGL-25 lamp (light intensity ˜0.7 mW·cm⁻²), a Prizmatix Mic-LED 420 nm LED (collimated LED power of 400 mW) and a Prizmatix Mic-LED 460 nm LED (collimated LED power of 215 mW) as blue light sources, and a Prizmatix 520 nm Ultra High Power (UHP) Mic-LED LED (collimated LED power of 900 mW).

### Example 2

### Synthesis of Photochromic Compounds

Azobenzene A1 is a commercial product purchased from Sigma-Aldrich. Azo derivatives A2, A3, A4, A5, A6, A7, and A8 and spiropyran were synthesized based on previously reported literature procedures.

Synthesis of 4-methoxy-tetra-ortho-fluoroazobenzene (A5=compound 3): A mixture of 4-hydroxy-tetra-ortho-fluoroazobenzene (135 mg; 0.5 mmol), iodomethane (1 mL), and potassium tert-butoxide (67 mg; 0.6 mmol) was refluxed overnight in 10 mL dry tetrahydrofuran in a sealed tube. Then, the solvent was evaporated, and the residue was dissolved in dichloromethane (50 mL) and washed with deionized water (2×100 mL). The organic phase was separated, dried over MgSO₄, and concentrated in vacuo. The obtained crude product was purified silica gel column chromatography (eluent: hexane/dichloromethane=3/1) to afford 95 mg of 3 (yield=67%).

¹H NMR (400 MHz, CDCl₃): δ=7.35-7.27 (m, 1H), 7.03 (t, 2H), 6.61-6.58 (d, 2H), 3.88 (s, 3H). ¹³C NMR (100 MHz, CDCl₃): δ=162.78 (t, ³J_{CF}=14.0 Hz), 157.61 (dd, ¹J_{CF}=259.9 Hz, ³J_{CF}=7.1 Hz), 155.63 (dd, ¹J_{CF}=257.6 Hz, ³J_{CF}=4.3 Hz), 132.25 (t, ²J_{CF}=10.0 Hz), 130.52 (t, ³J_{CF}=10.3 Hz), 126.17 (t, ²J_{CF}=9.4 Hz), 112.65 (m), 99.07 (dd, ²J_{CF}=24.0 Hz, ⁴J_{CF}=3.1 Hz), 56.34 (s). HRMS calcd for C₁₃H₉F₄N₂O [M+H]⁺, m/z=285.0651; found, 285.0645.

### Example 3

### Derivatizing Glass Slides with Polysiloxane Nanofilament Networks and Dispersing Photochromic Compounds

Glass slides (26 mm×56 mm) were roughened by in situ growth of a network layer of polysiloxane nanofilaments, which can be achieved by either vapor phase deposition technique or dip-coating method, as reported in previous work. Here, dip-coating method is adopted due to its simpler procedure. Specifically, each glass slide was immersed in a stirred toluene solution of trichloromethylsilane (0.3% v/v) in air with relative humidity of ˜35%. After 0.5 h, the glass slide was removed from the solution, washed with toluene, ethanol, and water, and finally dried under a nitrogen flow. The average thickness of the porous polysiloxane nanofilament network layer, estimated from cross-section views of SEM image, was ˜1.6 μm.

Photochromic compounds were deposited onto the surface of polysiloxane nanofilament-roughened glass slides by dipping the polysiloxane nanofilament-coated glass slide in a stock solution of the corresponding compound in toluene (concentration=12 mM unless stated otherwise), followed by drying in the air. It was verified that the amount adsorbed depended mainly on the concentration of the stock solution concentration and was largely independent of the dipping time. To facilitate the analysis of the adsorbed molecules by UV/Vis absorption spectroscopy, a spectrum of the glass slide before depositing the photochromic compounds was recorded and used as the baseline. In a typical procedure, a polysiloxane nanofilament-coated glass slide was used as the baseline, A1 was deposited on the glass slide by dipping it in a 12 mM solution of A1 in toluene, and a UV/Vis absorption spectrum was recorded (blue curve in FIG. 7). The spectrum exhibits a band characteristic of azobenzene dissolved in a liquid solvent, indicating a successful dispersion of A1 on the surface. The molecular density (σ) of A1 on the surface was determined as 21.7 nmol·cm⁻². Despite the high surface coverage, no shift in λ_{π→π*} or baseline increase was observed, indicating that A1 was well dispersed within the porous medium of polysiloxane nanofilaments. As a control experiment, bare glass slide was dipped in the same stock solution, resulting in the adsorption of only a small amount of azobenzene (red curve in FIG. 7). However, the adsorbed molecules are aggregated; note the red-shift and peak broadening of the π→π* absorption band, accompanied by a pronounced baseline increase.

Importantly, the adsorbed A1 could be quantitatively removed from the polysiloxane nanofilament-coated glass slide by washing with a good solvent (FIG. 8) and the slide can be reused for dispersing another chromophore.

Interestingly, absorbance at λₘₐₓ increased linearly with molecular density (σ) of photoswitches immobilized on the surface. It was found that the slope of the linear curve equals to 2ε:

$${Abs}_{{λ}_{m ax}} = ɛ cl = ɛ \frac{n}{v} \cdot 2 d = ɛ \frac{n}{2 d \cdot {S}_{G}} \cdot 2 d = ɛ \frac{n}{{S}_{G}} = ɛ \cdot 2 \frac{n}{{S}_{G}} = ɛ \cdot 2 σ \qquad ( E2 )$$

where:
ε is the molar absorption coefficient of the adsorbed chromophore;
c is the molar concentration of the chromophore adsorbed in the porous polysiloxane nanofilaments network, i.e., the “solvent box” in bottom of FIG. 1A;
l is the path length (twice the coating thickness d);
n is the total molar amount of chromophore adsorbed on both sides of the glass slide;
v is the space volume of the “solvent box”;
S_{G} is the size of the glass slide, equal to half of the apparent area of the coating (S_{C}).

It follows that:

$${2}_{ɛ} = \frac{{Abs}_{{λ}_{m ax}}}{σ} = {k}_{slope} \qquad ( E3 )$$

where
σ is the molecular density of the photoswitch on the surface;
kₛₗₒₚₑ is the slope of the curve (see, e.g., FIG. 3F).

### Example 4

### Photoswitching of A2-A6 on Polysiloxane Nanofilament Network-Roughened Glass Slides

In addition to A1, several other azo derivatives have been tested to verify whether the disclosed method can serve as a general method in dispersing and guiding the photoisomerization of photochromic compounds. Examples include azobenzenes with a short hydrophobic (A2) and hydrophilic chain (A3), red-shifted azobenzenes A4 and A5, and azopyrazole A6 (see FIGS. 1A and 16A).

TABLE 1
Photoswitching properties of A1-A6 immobilized on
the polysiloxane nanofilament-roughened surface.

| Molecular | σ_{Azo}^{a)} | λ_{Π→Π*} | Abs_{Π→Π*} | λ₁^{b)} | cis_{PSS} | λ₂^{c)} | trans_{PSS} | τ_{1/2}^{d)} |
|---|---|---|---|---|---|---|---|---|
| photoswitch | (nmol · cm⁻²) | (nm) | (a.u.) | (nm) | (%) | (nm) | (%) | (h) |
| A1 | 21.7 | 343.0 | 1.038 | 365 | 91 | 460 | 80 | 2.0 |
| A2 | 22.1 | 343.5 | 1.086 | 365 | 93 | 460 | 79 | 10.2 |
| A3 | 18.8 | 345.5 | 1.068 | 365 | 95 | 460 | 80 | 31.5 |
| A4 | 23.8 | 303.0 | 0.464 | 520 | 81 | 420 | 89 | 41.5 |
| A5 | 20.3 | 327.0 | 0.983 | 520 | 80 | 420 | 83 | 737.4 |
| A6 | 20.6 | 330.0 | 0.933 | 365 | 92 | 520 | 92 | 15.2 |

^{a)}Surface density of molecular photoswitch (stock solutions of c = 12 mM were used in all cases);
^{b)}Wavelength of light used for trans-to-cis isomerization;
^{c)}Wavelength of light used for cis-to-trans isomerization;
^{d)}Half-life of the cis-isomer in dark.

### Example 5

### Accelerated Thermal Back-Isomerization of Azobenzene Upon Immobilization

It was found (FIG. 14) that the rate constant k for thermal relaxation of azobenzene A1 in solution increased with decreasing solvent polarity. Nevertheless, replacing the most polar solvent methanol with the least polar hexane resulted in an only two-fold increase in k (from 0.011 h⁻¹ to 0.022 h⁻¹). In DMSO, an intermediate value of back-isomerization rate constant was observed (0.014 h⁻¹). Since DMSO is an excellent solvent for various substituted azobenzenes, it was used as a model solvent in further experiments (FIGS. 15 and 16).

FIG. 16A summarizes the results of a study of the effect of azobenzene structure on the kinetics of thermal relaxation. It was found that A1 relaxed ˜25 times faster when transferred from a DMSO solution onto a polysiloxane nanofilament network surface. This remarkable acceleration could be attributed to the reduced steric hindrance experienced by azobenzene dispersed within the polysiloxane nanofilament network and the superhydrophobic nature of the polysiloxane nanofilament network. Replacing A1's methyl group with increasingly longer alkyl chains (A2 and A7) decreased the acceleration effect. Azobenzenes A7 and A8 are appended with substituents of similar lengths but of varying polarities. The more polar chain of A8 gave rise to a smaller acceleration effect (1.9-fold vs. 2.3-fold). The effect was more pronounced for A3, appended with the longest chain (only 1.6-fold acceleration).

### Example 6

### Irradiation of Immobilized Spiropyran with Extremely Weak UV Light

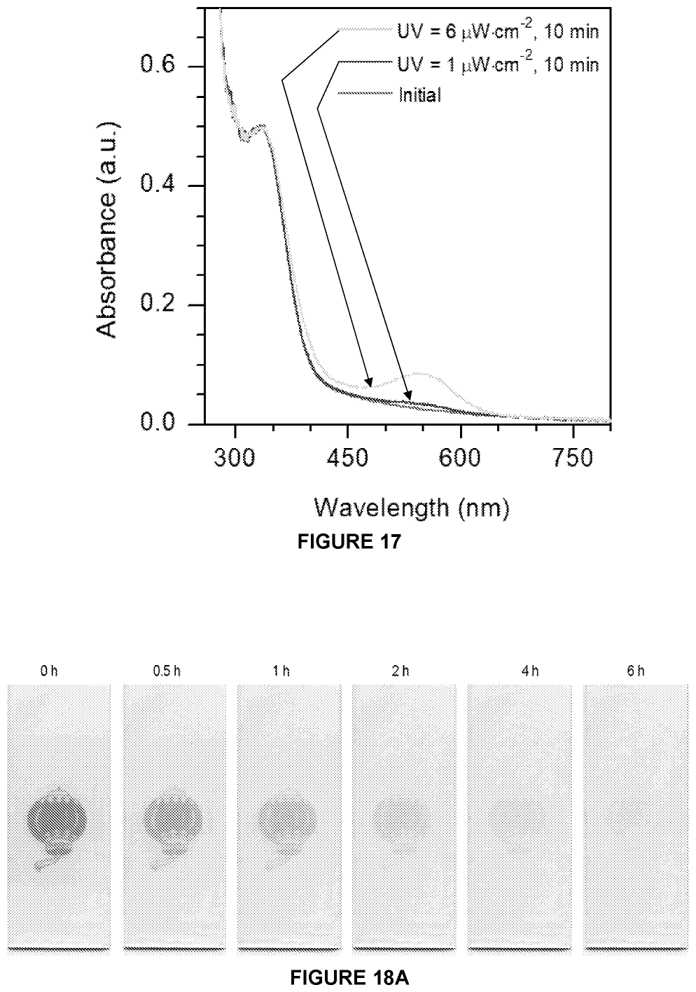

It was found that spiropyran deposited onto a polysiloxane nanofilament network-roughened surface was extremely sensitive to UV irradiation (FIG. 17). Detectable increase in absorbance in the visible region could be seen after exposing to UV light as low as 1 μW·cm⁻² for 10 min. At a UV light intensity of 6 μW·cm⁻², 10 min UV exposure can generate a significant amount of merocyanine isomer.

### Example 7

### Thermal Back-Isomerization of Immobilized Spiropyran

FIG. 18A shows a gradual disappearance of an image created in a polysiloxane nanofilament network-roughened glass slide in the presence of spiropyran; residual absorption due to the ring-open merocyanine form can still be seen after 50 h (FIG. 18B). It was found that the spontaneous ring closing reaction deviates from the first-order kinetics (FIG. 18C), which can be attributed to merocyanine di/oligomerization. To support this hypothesis, samples were exposed to UV light (0.7 mW·cm⁻²) for 30 sec and for 10 min, resulting in the formation of different amounts of the merocyanine isomer (FIG. 18D). Indeed, the longer exposure time resulted in a decreased rate of back-isomerization (FIG. 18E). The sample pre-exposed to 10 min of UV light was allowed to relax until the absorbance at λₘₐₓ (554 nm) reached the level achieved with 30 sec of UV light (FIG. 18F). As FIG. 18G shows, the sample allowed to relax immediately after a short exposure to UV (30 sec), switched to the ring-closed form much faster than the sample that was pre-exposed to 10 min of UV light.

### Example 8

### Materials and Methods for Polysilsesquioxane Nanowire Networks as an “Artificial Solvent” for Reversible Operation of Photochromic Molecules

All chemicals were of analytical grade and were used as received. 1H and 13C NMR spectra were recorded on a Bruker Avance III 400 MHz (for the characterization of 3) or a Bruker Avance III HD 500 MHz (for determining the compositions of the photostationary states (PSSs)) NMR spectrometer. Chemical shifts (δ) in the 1H NMR spectra are reported in parts per million (ppm) relative to residual solvent resonances (2.51 ppm for DMSO-d6 or 7.26 ppm for CDCl₃). Multiplicities in the 1H NMR spectra are reported as s (singlet), d (doublet), t (triplet), and m (multiplet). Chemical shifts (δ) in the 13C NMR spectra are reported in ppm relative to TMS relative to residual solvent resonances (77.16 ppm for CDCl₃). For determining the compositions of PSSs on PNN-coated substrates, the substrates were washed extensively with CDCl₃ or DMSO-d6 in the dark and the NMR spectra of the resulting solutions were rapidly recorded. It was verified for all azo compounds, (by monitoring thermal back-isomerization in solution) that the delay between washing the substrates and recording the spectrum did not cause changes in the compositions of the PSSs. Electrospray ionization mass spectrometry (ESI-MS) measurements were carried out on a Waters Micromass Q-TOF spectrometer. Scanning electron microscopy (SEM) was carried out on a Zeiss Ultra-55 microscope. Solution and solid-state UV/Vis absorption spectra were recorded on a Shimadzu UV-2700 spectrophotometer. For all the solid-state absorption spectra, glass slides derivatized with thin layers of polysilsesquioxane nanowire networks (PNNs) were used as the baseline. For photoirradiation experiments, the following sources have been used: a 365 nm UVP UVGL-25 lamp (light intensity ˜0.7 mW/cm²) as the UV light source, a 420 nm Prizmatix Mic-LED light-emitting diode (LED) and a 460 nm Prizmatix Mic-LED LED as blue light sources (both LEDs had a collimated LED power of 400 mW), and a 520 nm Prizmatix Ultra High Power (UHP) LED (collimated LED power of 900 mW) as the green light source.

Synthesis of Photochromic Compounds:

Compound 1 was purchased from Sigma-Aldrich. Compounds 2, 4, 5, 6, 7, 8 and 9 were synthesized based on previously reported procedures. Compound 3 was synthesized in one step from the previously reported 2,2,2′,2′-tetrafluoro-4-hydroxyazobenzene as described below.

2,2,2′,2′-tetrafluoro-4-methoxyazobenzene (3): A solution of 2,2,2′,2′-tetrafluoro-4-hydroxyazobenzene (135 mg; 0.5 mmol), iodomethane (1 mL), and potassium tert-butoxide (67 mg; 0.6 mmol) in dry THF (10 mL) was refluxed overnight in a sealed tube. Then, the solvent was evaporated in vacuo and the solid residue was dissolved in dichloromethane (50 mL). The resulting solution was washed with deionized water (100 mL×2), dried over MgSO₄, and concentrated under in vacuo. The obtained crude product was purified using silica gel column chromatography (eluent: hexane/dichloromethane=3:1) to afford 95 mg of 3 (yield=67%).

Derivatizing Glass Slides with Polysilsesquioxane Nanowire Networks (PNNs):

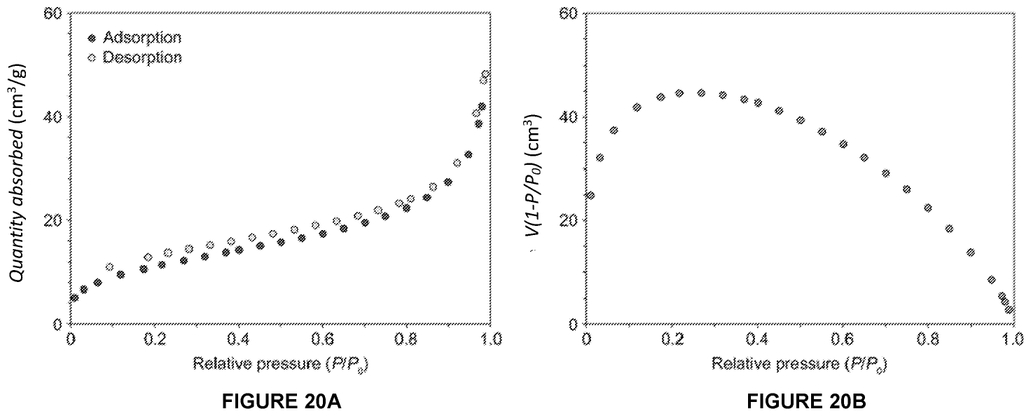

Glass slides (26 mm×56 mm) were derivatized with PNNs using a dip-coating method previously reported. A glass slide was immersed in a vigorously stirred solution of trichloromethylsilane in toluene (c=0.3%, v/v) in humid air (relative humidity 35%). After 30 min, the slide was removed from the solution, washed consecutively with toluene, ethanol, and water, and finally dried with a stream of nitrogen. This procedure resulted in a 1.6-μm-thick layer of PNNs (based on SEM imaging). The same procedure was used to fabricate PNNs on indium tin oxide (ITO), aluminum, and stainless steel. To prepare a sample of freestanding PNNs, the same procedure was performed without any solid substrate. BET surface area of freestanding PNNs was determined. The sample (50 mg) was degassed overnight at 150° C. and the surface area was calculated from N₂ isotherms measured at 77 K (FIG. 20A) using BET theory, in the range of relative pressure determined by the Rouquerol plots (FIG. 20B; 0.1-0.25).

Depositing Photochromic Compounds onto PNN-Derivatized Surfaces:

A PNN-derivatized glass slide was immersed in a toluene solution of a photochromic compound (c=12 mM unless stated otherwise) for 1 s and then dried in air. Longer immersion times did not increase the amount of photochromic compound deposited within the PNNs.

PNN-derivatized glass slides doped with photochromic compounds were characterized by UV/Vis absorption spectroscopy (PNN-derivatized glass slides prior to dipping in a solution of a photochromic compound were used as the baseline). FIG. 7 shows a solid-state absorption spectrum of a PNN derivatized slide after dipping in a 12 mM solution of 1. A sharp peak (centered at the same wavelength as 1 in toluene solution) and no absorption in the high-wavelength region are indicative of efficient dispersion of 1 within the PNNs. For comparison, an identical glass slide but without a PNN layer was immersed in the same solution of 1. Solid-state absorption spectrum of this slide features a much broader and red-shifted band centered at Amax 350 nm, indicative of H-aggregation, and increased absorption throughout the spectrum is due to light scattering by the crystallized 1. The amount of adsorbed 1 is significantly lower than that within PNN-roughened glass.

The amount of photochromic compound deposited on PNN-roughened glass slides was estimated by washing the slides with toluene and analyzing the resulting solution by UV/Vis absorption spectroscopy. Surface coverage, a, was calculated assuming that a 1.6 μm thickness of the PNN layer covers both sides of each glass slide. It was found that the a value of all the photochromic compounds scaled linearly with the concentration of their toluene solutions, in which the slides were immersed (see, e.g., FIG. 1D for compound 1).

To verify that washing with toluene quantitatively removes the absorbed compound from the PNN roughened glass, UV/Vis spectra of the slides after washing were recorded. It was found that the absorption of these slides was identical to that before the deposition of photochromic compound (i.e., baseline absorption, as shown in FIG. 8 for 1 as an example). Importantly, desorbing a photochromic compound with a good solvent regenerated the original PNN-coated glass slide, which could subsequently be used for the deposition of another compound. It was verified that repeated absorption/desorption cycles did not affect the quality of the PNN layers.

### Example 9

### Polysilsesquioxane Nanowire Networks as an “Artificial Solvent” for Reversible Operation of Photochromic Molecules

As discussed above, efficient isomerization of photochromic molecules often requires conformational freedom and is typically not available under solvent-free conditions. In this example, further evidence is provided for the disclosed general methodology allowing for reversible switching of such molecules on the surfaces of solid materials. This example shows an aspect of the method that is based on dispersing photochromic compounds within polysilsesquioxane nanowire networks (PNNs) which can be fabricated as transparent, highly porous, micrometer-thick layers on various substrates. It was found that azobenzene switching within the PNNs proceeded unusually fast compared with the same molecules in liquid solvents. Efficient isomerization of another photochromic system—spiropyran—from a colorless to a colored form was used to create reversible images in PNN-coated glass. The coloration reaction could be induced with sunlight and is of interest for developing “smart” windows.

Photochromic molecules are molecules that can be reversibly switched between different forms using light. Each of these forms has distinct optical properties. Such transformations often entail changes in other properties of the system. For example, light-induced molecular form switching has been used to modulate magnetic properties, ion binding, catalysis, aggregation of metallic nanoparticles and flow in microfluidic devices. However, isomerization in photochromic molecules is often accompanied by pronounced conformational/configurational/structure changes, and it requires large degree of conformational freedom. Consequently, most of the above functions are limited to solutions and soft materials, which greatly limits the scope of applications of photochromic compounds. Therefore, a general methodology allowing for reversible operation of photochromic molecules on/within solid materials would be highly beneficial and desirable.

This example provides an additional evidence for reversible isomerization of switchable molecules within a solid-state medium combining nanoporous and nonpolar properties. The nonpolar nature of such a medium would ensure an efficient dispersion of the typically nonpolar molecular switches (i.e., no aggregation), whereas the high porosity would result in high levels of doping. An ideal medium would be chemically robust, transparent in the visible region or in portions thereof, and could be deposited as thin layers on various substrates.

To meet these criteria, the focus was on polysilsesquioxane nanowire networks (PNNs). PNNs are intertwined networks of one-dimensional filaments (typically several micrometers long and less than 100 nm in diameter; FIG. 1B), which can be fabricated on a wide range of surfaces by hydrolysis of methyltrichlorosilane (FIG. 1A; see also Example 8 herein above). These nanowires expose multiple methyl groups and consequently, feature low surface energy which when combined with the highly porous structure of the networks, gives rise to the superhydrophobicity of the surfaces derivatized with PNNs. In fact, it has long been known that water droplets deposited on PNN-coated surfaces assume near-spherical shapes. However, impregnation of PNNs with nonpolar compounds, in particular photochromes, has remained unexplored.

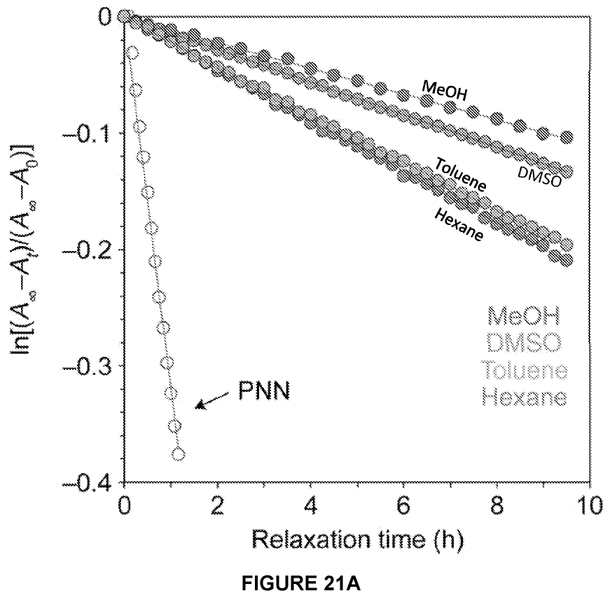

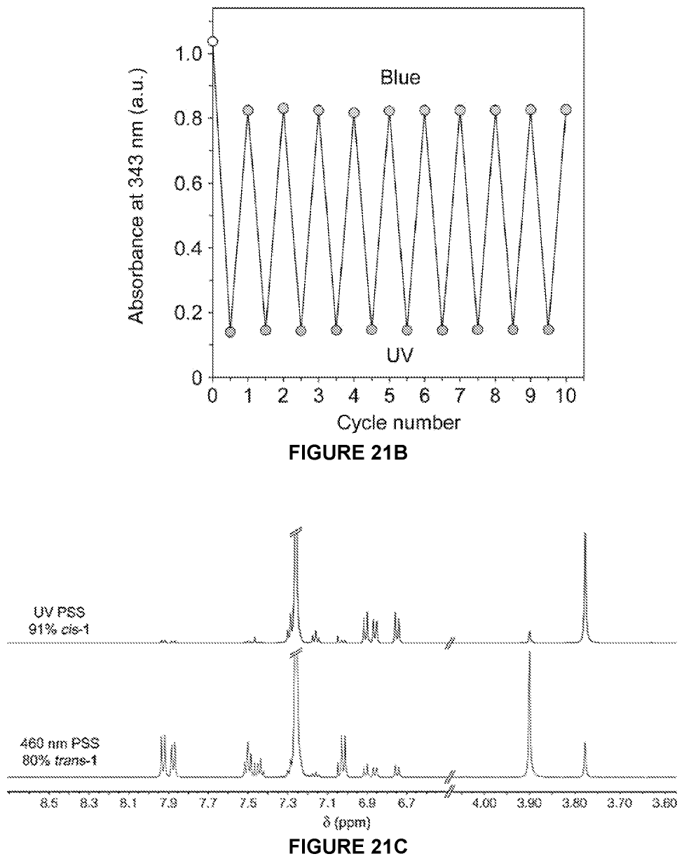

The study shown in this example started with 4-methoxyazobenzene 1 (FIGS. 1C and A1=1 in FIG. 1A) as a model, a structurally simple azobenzene. Eight identical PNN-roughened glass slides (PNN thickness≈1.5 μm) were dipped in toluene solutions with increasing concentrations of 1 (c1). Following immersion for 1 s, the slides were dried extensively for complete removal of the solvent and solid-state UV/Vis spectra were recorded (FIG. 1C). All the spectra featured a sharp peak due to the π→π* transition in trans-azobenzene; the position of this peak (λmax=343 nm) was identical to that of 1 in toluene solution, suggesting that upon adsorption within PNNs, 1 remained in a non-aggregated state. This observation suggests that an array of PNNs behaves as an “artificial solvent” for 1. In contrast, 1 deposited on a bare glass slide exhibited a red-shift in the π→π* band and increased absorption in the high-wavelength region, indicative of aggregation and crystallization (FIG. 21A-21C).

The amount of 1 adsorbed on PNN-roughened glass was determined by thoroughly washing the slides with toluene and analyzing the resulting solution by UV/Vis spectroscopy (see Example 8). It was found that the surface concentration of 1 (σ1) scaled linearly with and could be controlled by c₁ (FIG. 1D). Importantly, an optically transparent, ˜1.5 μm-thick layer of PNNs allowed for a σ equivalent to ˜200 times those typical for self-assembled monolayers (SAMs). In fact, PNN-roughened glass slides deposited in azobenzene solutions assumed an intense yellow color. Similar control of σ was possible with other photochromic compounds reported herein below.

To better understand the high capacity of thin layers of PNNs towards 1 (and toward other photochromic compounds; see below), the Brunauer-Emmett-Teller (BET) surface area of PNNs was determined. To this end, a sample of PNNs was prepared according to the procedure described above (see Example 8) but in the absence of a solid substrate. Note that the amount of PNNs within a 1.5 μm-thick layer is too small to determine the surface area. This procedure afforded a white powder of PNNs (FIG. 1D, inset) with a structure (determined by scanning electron microscopy) indistinguishable from that of surface-bound PNNs. These freestanding PNNs exhibited a surface area of 207 m²/g, which, assuming polysilsesquioxane's density of 1 g/cm³ and PNN layer's thickness of 1.5 amounts to a ˜330-fold increase in the surface area of PNN-roughened glass, compared to a non-derivatized (flat) glass slide.

To further characterize the PNNs, their structural robustness at increased temperatures was studied. Specifically, PNNs deposited on a silica-coated Si wafer were placed inside an environmental scanning electron microscope operating at 0.04 atm and equipped with an in-situ heating stage. A series of images was recorded while raising the temperature from 30° C. to 800° C. within 100 min and then incubating the sample at 800° C. for an additional 20 min (see Example 8). Remarkably, virtually no changes in the structure of the PNNs could be seen. This corroborates the view of PNNs as a solid-state “solvent” (see FIG. 1F).

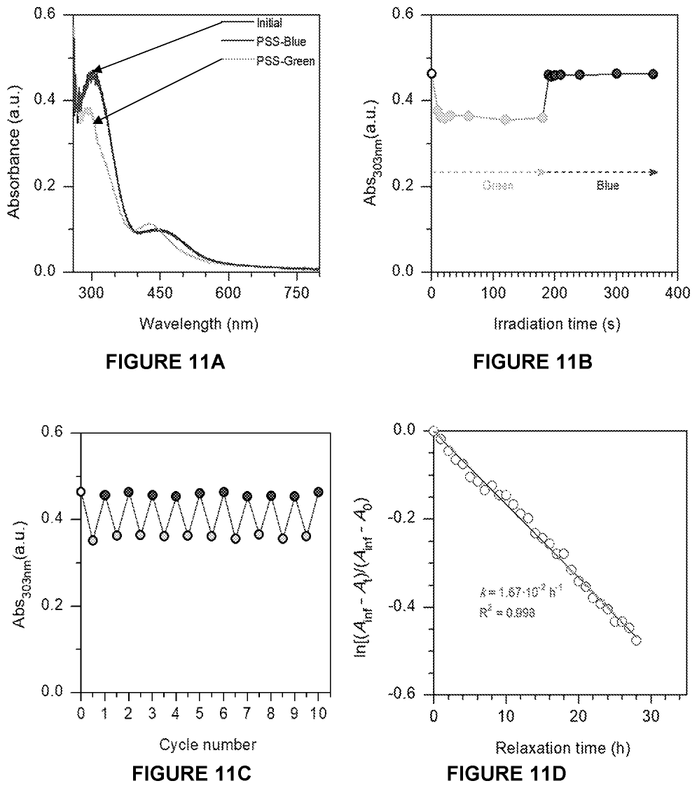

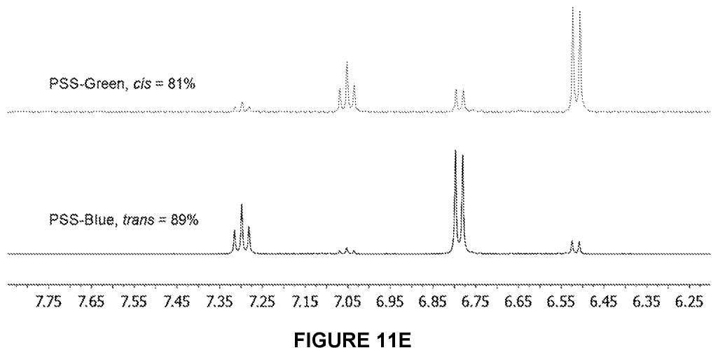

Next, light-induced switching of photochromic compounds within the PNNs was investigated. Upon exposure to UV light in solution, 1 undergoes a trans→cis isomerization (FIG. 2A). Interestingly, efficient photoswitching was also observed upon irradiation of 1-doped, PNN roughened glass with a low-intensity UV (365 nm) lamp, as evidenced by the decrease in the 343 nm peak and a concomitant increase in the ˜430 nm band due to the n→π* transition in cis-1 (FIG. 2B). To analyze the composition of the resulting photostationary state (PSS), the glass slides were treated with CDCl₃ and the obtained solution was analyzed by NMR. It was found that ˜91% of 1 was converted to the cis isomer, similar to the conversion efficiency in solution. Subsequent irradiation with a 420 nm (blue) light-emitting diode, resulted in a rapid (FIG. 2D) back-isomerization, and a PSS containing ˜80% trans was established. Notably, the compositions of the PSSs did not depend on σ₁, and the reversible photoswitching could be repeated for many cycles (FIG. 11). These observations confirm the behavior of PNNs as an “artificial solvent”. Moreover, 1 remained photoswitchable after being deposited within PNNs for at least eight months.

To characterize the surprisingly fast back-reaction, a series of UV/Vis spectra following thermal back-isomerization in the dark were recorded (FIG. 2E). The linear dependence of ln[(A_{∞}−Aₜ)/(A_{∞}−A₀)] vs. t (where A_{∞}, A₀, and Aₜ denote absorbance at 343 nm before irradiation, immediately after UV irradiation ceases, and after time t, respectively), indicates that the reaction follows first-order kinetics (FIG. 2E, inset), analogously to back-isomerization in solution. The slope of the curve allowed to determine the rate constant as k=0.35 h⁻¹, which corresponds to a thermal half-life, τ_{1/2}, of ˜2 h. This half-life is unusually short for a simple azobenzene such as 1, for which solution τ_{1/2} values range between ˜32 h and ˜65 h, depending on the solvent polarity (FIG. 11). The accelerated kinetics of back isomerization can be rationalized by:
i) the absence of a liquid solvent that would otherwise solvate the photochromic molecules, thus decelerating their conformational changes; and
ii) the strongly hydrophobic nature of PNNs that made them repel stray water molecules which could otherwise bind to and stabilize cis-azobenzene.

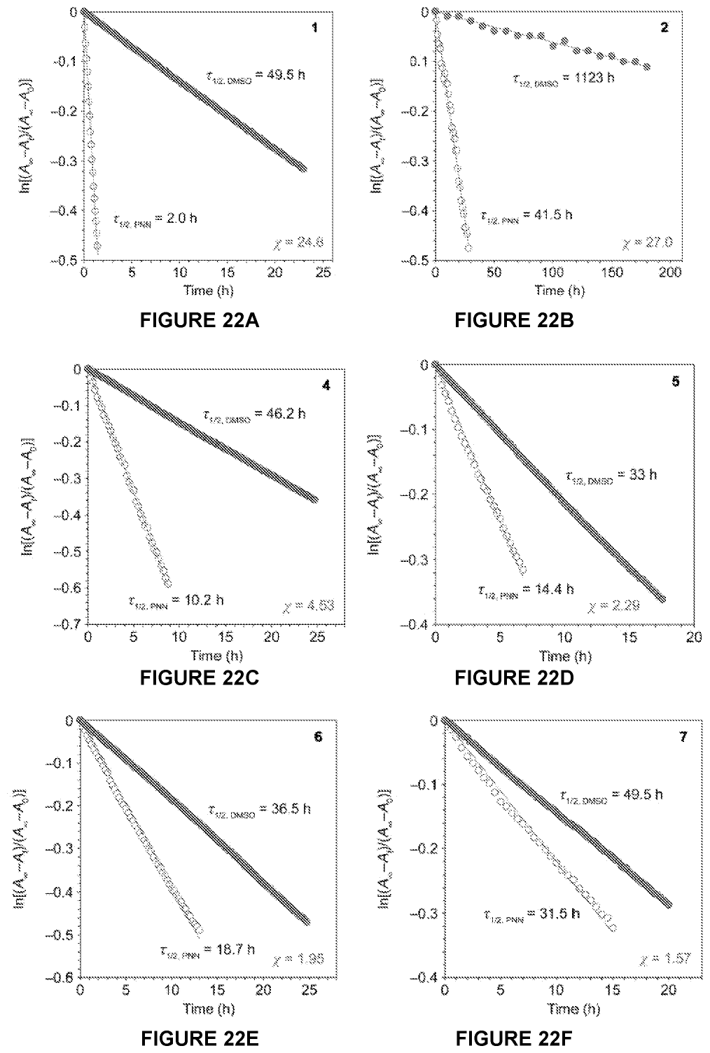

To better understand the fast switching of azobenzenes within PNNs, additional azo compounds 2-7 have been tested (FIG. 19A and FIGS. 9-12 and 22). Results for the various compounds were as follows:

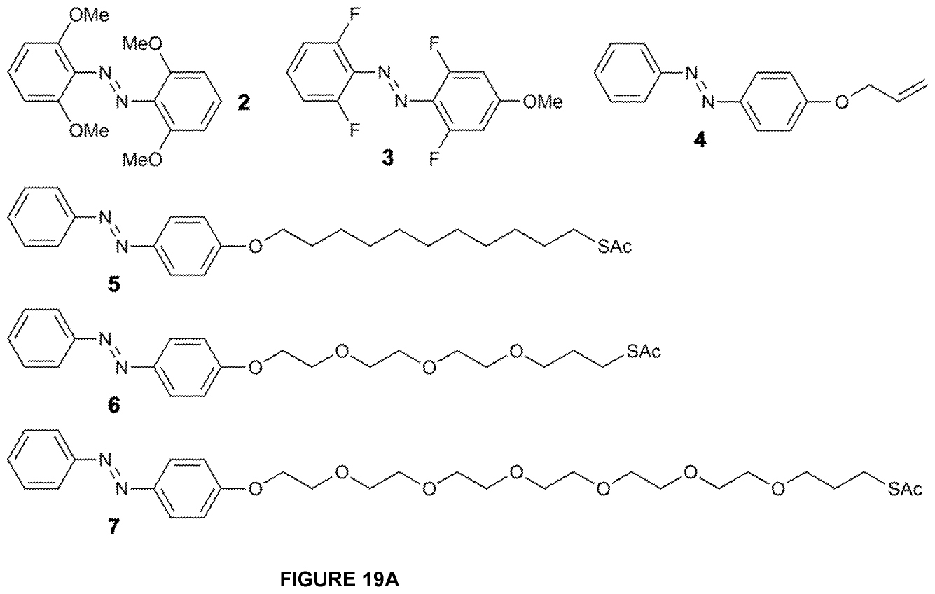

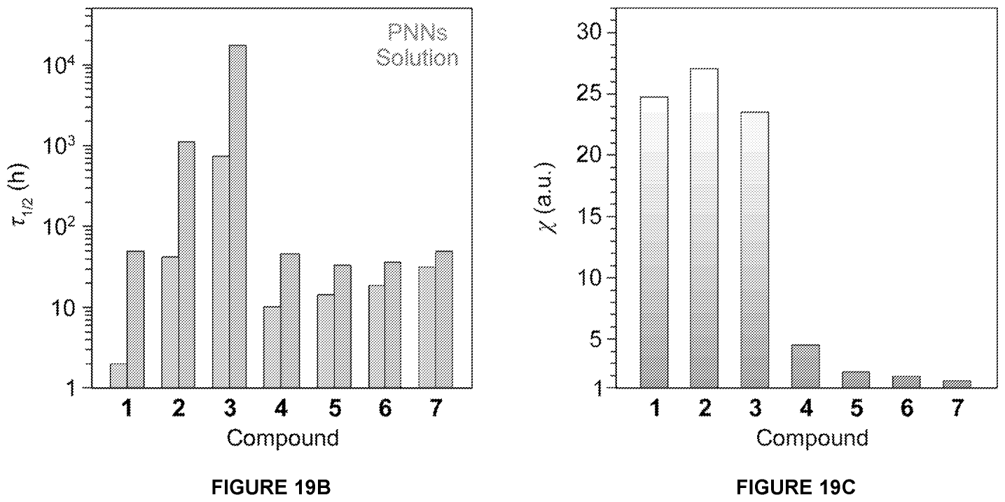

Tetra-o-methoxyazobenzene 2 exhibits the τ_{1/2} value of ˜1.5 months in DMSO—a value, which decreased to ˜40 h on PNN-roughened glass (FIG. 2B). Similarly, τ_{1/2} of the fluorinated derivative 3 dropped from ˜2 years to only ˜1 month upon “dissolving” within PNNs. Remarkably, despite the large differences in the absolute values of τ_{1/2}, all three azobenzenes 1-3 exhibited a ˜25-fold acceleration effect (χ) in the cis→trans reaction kinetics upon transfer from DMSO solution into PNNs (see FIG. 19C).

Interestingly, appending the azobenzene core with extended chains greatly reduced χ, with the half-lives of the cis isomers approaching the solution's τ_{1/2} values. For 4-allylazobenzene 4, a much smaller χ value of ˜4.5 was observed. The increased (compared to 1-3) stability of the cis isomer was attributed to the intramolecular interactions between the allyl group and the phenyl ring on the opposite side of the molecule. Accordingly, this “intramolecular solvation” effect was more pronounced with the increasing length of the para substituent (5-7), with the long chain of 7 resulting in an only ˜1.6-fold acceleration within the PNNs compared with DMSO. These results suggest that the intrinsic rate of cis-azobenzene thermal back-isomerization is more than 25 faster than the rate in organic solvents. Interestingly, the presented results are in agreement with an earlier study, which focused on a different solvent-free system namely, self-assembled monolayers (SAMs) of azobenzene-terminated thiols on gold. Similar to the decreased half-life of cis-1 within PNNs, the τ_{1/2} value of the cis-azobenzene within SAMs in vacuum was found to be reduced to as little as several minutes.

Reduced half-lives of cis-azobenzenes have previously been reported under certain conditions. For example, it was demonstrated that weakly stabilized or bare metallic nanoparticles can catalyze the cis→trans transformation by temporarily reducing or oxidizing cis-azobenzene to species containing N—N single bond. Similarly, the presence of hydrogen-bond donors in the proximity of the cis-azo group can reduce the bond order of the N═N moiety, thus promoting the back-isomerization reaction. However, in the present system, it is unlikely that these two processes will occur given the absence of i) a suitable electron donor or acceptor and ii) an H-bond donor. Instead, the accelerated back-isomerization is due to the poor “solvation” by the essentially solid PNN “solvent”—a conclusion best supported by appending the azobenzene core with increasingly longer substituents, which “intramolecularly solvated” cis-azobenzene, creating an environment similar to a liquid solvent.

Next, the behavior of another photochromic system, spiropyran, within the PNNs has been investigated. Upon exposure to UV light in solution, the colorless, ring-closed isomer of spiropyran (8 in FIG. 3A) undergoes isomerization to the open, deep-colored merocyanine form (8′). Similar to azobenzene switching, the reaction requires conformational freedom and it typically does not occur in solvent-free media. In contrast, UV irradiation of glass slides coated with a thin layer of PNNs impregnated with 8 resulted in rapid and efficient coloration (FIG. 3B).

Interestingly, the blue color observed after the initial 5 s of irradiation turned purple and then pink with increasing irradiation time (see also FIG. 28B), which could be followed by monitoring the wavelength of the maximum absorption of 8′ (FIG. 3C). This color change can be explained by the formation of H-aggregates, which entails the diffusion of 8′. H-aggregation of merocyanines is well known in liquid solutions and it is contended that the current results further confirm PNNs' behavior as an “artificial solvent” in which “solutes” can readily diffuse. Upon subsequent exposure to 2 min of green light, the initial spectrum was regenerated, and the ring opening/closing reaction could be repeated for at least several cycles (FIG. 18J).

It was hypothesized that the pronounced color change associated with the 8→8′ conversion could be used to “write” reversible patterns in PNN-roughened glass doped with 8. Such patterns could be created by locally (i.e., through a mask) irradiating 8-doped PNN layers, with subsequent exposure to visible light inducing their erasure (FIG. 3D). Indeed, multiple high contrast, high-resolution images could be produced sequentially in the same piece of PNN-coated glass by repeated cycles of UV and green light irradiation (FIG. 3D).

The colored patterns could also disappear spontaneously—a consequence of the metastable nature of the 8′ isomer (FIG. 3A), although it took more than 8 h in the dark for the images to “self-erase” completely (FIG. 18A). It was found that this thermal decay of 8′ significantly deviated from the first-order kinetics (FIGS. 18K, 18L) which additionally confirms the involvement of dye aggregates in this process. Interestingly, spontaneous coloration of PNN-roughened glass doped with 8 could also be achieved using sunlight, indicating that the UV component of sunlight is far more efficient in inducing the 8→8′ transformation compared with the visible light component inducing the reverse reaction (the tests were carried out during early afternoon on a sunny winter day; T≈24° C. (see example 10 herein below). Importantly, the reversible switching of spiropyrans and azobenzenes did not affect the wettability of PNN-roughened surfaces which remained superhydrophobic, with water contact angles >150°.

The utility of our methodology was further demonstrated by reversibly operating molecular switches within PNNs deposited on flexible substrates. PNNs have previously been deposited on a range of flexible supports, including cotton fabric, silk and PDMS. All such flexible substrates are included as substrates in embodiments of this invention. Furthermore, the method is readily scalable: it has been shown that PNNs could be deposited on surfaces as large as 3.2 m×1.55 m. In this example, a layer of PNNs was prepared on top of a thin (50 μm) and flexible polypropylene (PP) sheet. Similar to PNN-roughened glass, the PNN-modified PP could be doped with high concentrations of photochromic compounds which retained their photoswitching characteristics. To demonstrate this proof-of-concept, an 8-doped, PNN-roughened PP sheet was exposed to UV light through a mask featuring the structural formula of 8′. The resulting high contrast image (FIG. 3I) could be erased with visible light and additional patterns could then be created in the same sheet.

In sum, it was shown that PNNs formed as transparent, micrometer-thick films on various substrates could be used for dispersing various photochromic compounds such as azobenzenes and spiropyrans. Surface concentrations of these photochromes could be predictably controlled and they could reach values equivalent to 200 times the concentrations achievable using SAMs. Photochromic compounds dispersed within the PNNs could be switched efficiently and for many cycles, despite the absence of any liquid solvent. All the compounds described herein remained stable within the PNNs but could rapidly be “extracted” using appropriate solvents, such as toluene or chloroform, regenerating the original PNN-derivatized substrate. This methodology can be extended to other switches, such as donor-acceptor Stenhouse adducts and other azo-switches (see for example photoswitching of azopyrazole in example 10 herein below). The methodology described herein paves the way towards developing novel applications of photochromic compounds. In particular, it is believed that the combination of switchable light transmission with permanent super-hydrophobicity is of interest for developing “smart” windows.

### Example 10

### Supplementary Results for Example 9; Polysilsesquioxane Nanowire Networks as an “Artificial Solvent” for Reversible Operation of Photochromic Molecules; Photoswitching of Azobenzenes on PNN-Roughened Glass

Experimental data supporting the results in FIG. 2 are shown in FIG. 21. Thermal half-lives of cis-1, τ½, showed relatively little dependence on the solvent; in contrast, a drastic reduction of τ½ was observed on PNN-roughened glass (FIG. 21A).

The behavior of several other azobenzenes on PNN-roughened glass has been studied. For all the azobenzenes except the red-shifted compounds 2 and 3, UV light (365 nm) was used for the trans→cis isomerization. For 2 and 3, green light (520 nm LED) was used instead. The cis→trans back-isomerization for all azobenzenes was accomplished with blue light or was allowed to proceed thermally in the dark. Detailed data for compounds 2, 3, 4, and 7 are shown in FIGS. 9-12 and 21.

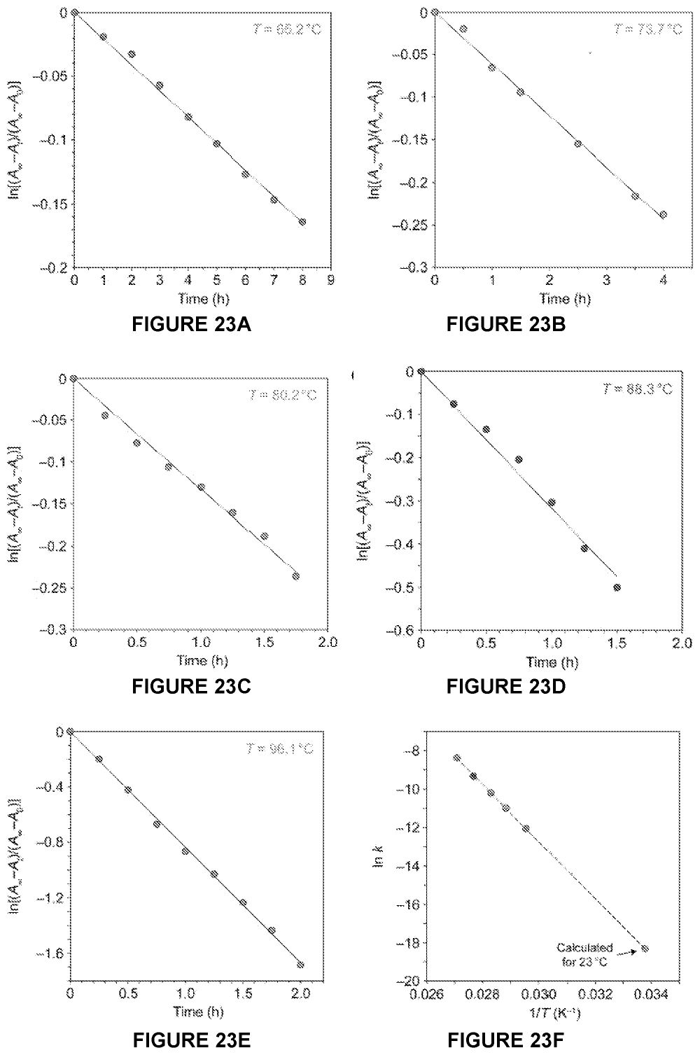

The thermal half-life of cis-3 in solution at room temperature is very long. To estimate it, the rate constants at several different temperatures in the range 65-96° C. (FIGS. 23A-23E) were first determined. Next, the results were extrapolated to room temperature (23° C.) using the Arrhenius equation (FIG. 23F) as described previously for other compounds with very long thermal half-lives.

Effect of Oxygen Plasma on Azobenzene Switching in PNN-Roughened Glass

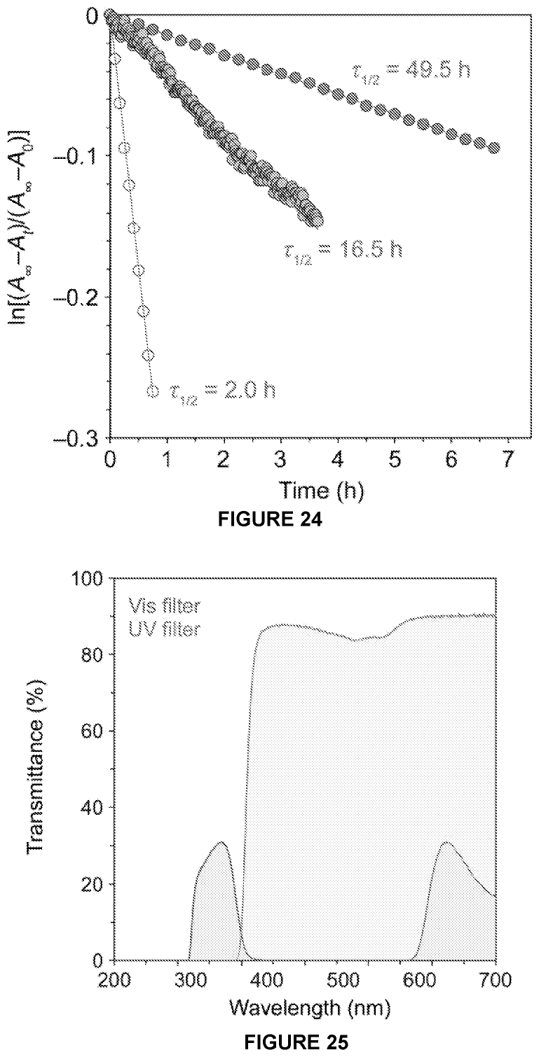

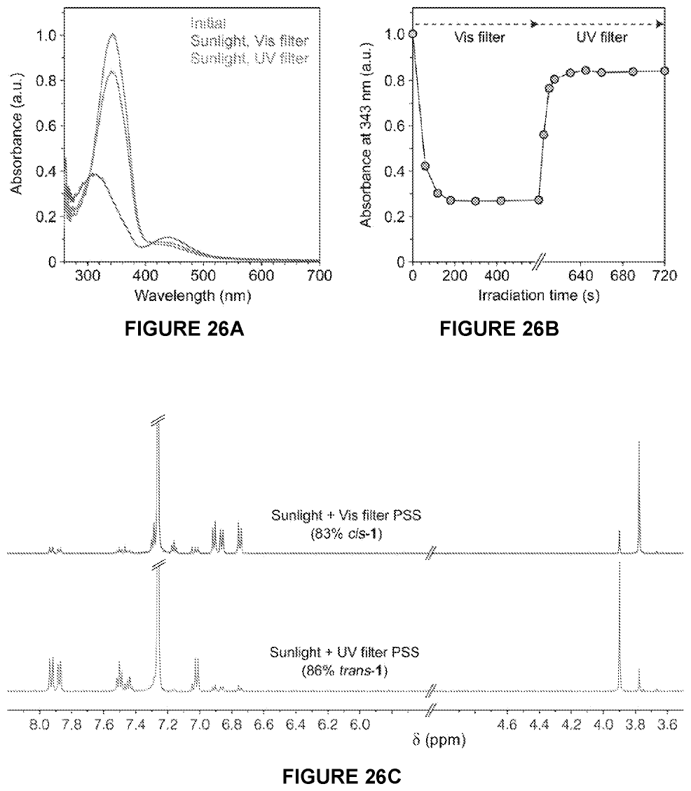

To investigate the effect of PNN surface polarity on the kinetics of the thermal relaxation of azobenzene, the behavior of 1 on native PNN-roughened glass slides was compared to the same slides treated with oxygen plasma. Oxygen plasma generates surface Si—OH species, thereby significantly increasing the surface polarity. The high-polarity environment can stabilize the polar, cis isomer of azobenzene, as previously reported. Consequently, the spontaneous (dark) back-isomerization reaction is expected to proceed slower. Indeed, it was found that treating PNN-roughened glass slides with oxygen plasma dramatically increased the τ½ value of 1 from 2.0 h to 16.5 h (FIG. 24).

Photoswitching of Spiropyran on PNN-Roughened Glass

Additional data on 8-doped PNN layers (see FIG. 3) are shown in FIG. 18. It was found that the thermal decay of 8′ significantly deviated from first-order kinetics (FIG. 18K), which can be attributed to the di- or oligo-merization of the zwitterionic merocyanine species, as previously reported. To confirm this hypothesis, the decay of 8′ generated in 8-doped, PNN-roughened glass slides by exposing them to UV light for two different amounts of time (30 sec and 10 min; FIG. 18L) was followed, assuming that 8′ in the slide exposed to prolonged UV irradiation would have enough time to diffuse to form the relatively stable 8′ aggregates. Indeed, 8′ in the sample exposed to 10 min of UV light decayed considerably slower (FIG. 18L). It was not possible to determine the compositions of the 8/8′ PSSs within PNN layers using the method adapted for the azo compounds—in all the solvents that were tested for desorbing 8/8′ from PNN-coated substrates, the 8′→8 back-isomerization proceeded rapidly.

Photoswitching with Sunlight

Experiments with PNN-roughened glass slides doped with azobenzene 1 were carried out during early winter afternoon on Dec. 15, 2018. Experiments with PNN-roughened glass slides doped with spiropyran 8 were carried out during early afternoon on Feb. 4, 2019. On both days, the weather was sunny, with a temperature of ˜24° C. As the “visible filter”, a combination of a UVP 98-0118-02 filter (allowing light of 250-400 nm and >700 nm to pass through) and polyethylene terephthalate (UV filter with a ˜320 nm cutoff) have been used. Together, these filters allowed UVA light (320-400 nm) to pass through (in addition to NIR light, which none of the photochromic compounds tested here absorbs; FIG. 25). For the UV filter, polycarbonate was used (˜400 nm cutoff; FIG. 25). The UV intensity of sunlight was determined as ˜0.5 mW/cm² with this “visible filter” and ˜1.8 mW/cm² without any filter.

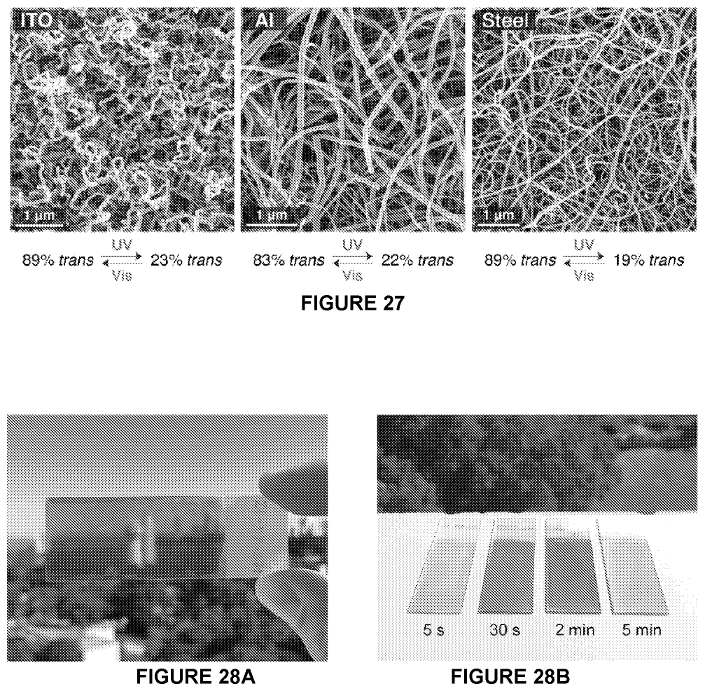

It was also verified that efficient switching between PSSs featuring ˜20% and >80% of trans-1 using sunlight could also be achieved within PNNs fabricated on other materials, such as indium tin oxide (ITO), aluminum, and stainless steel (FIG. 27).

Photoswitching of Azopyrazole on PNN-Roughened Glass:

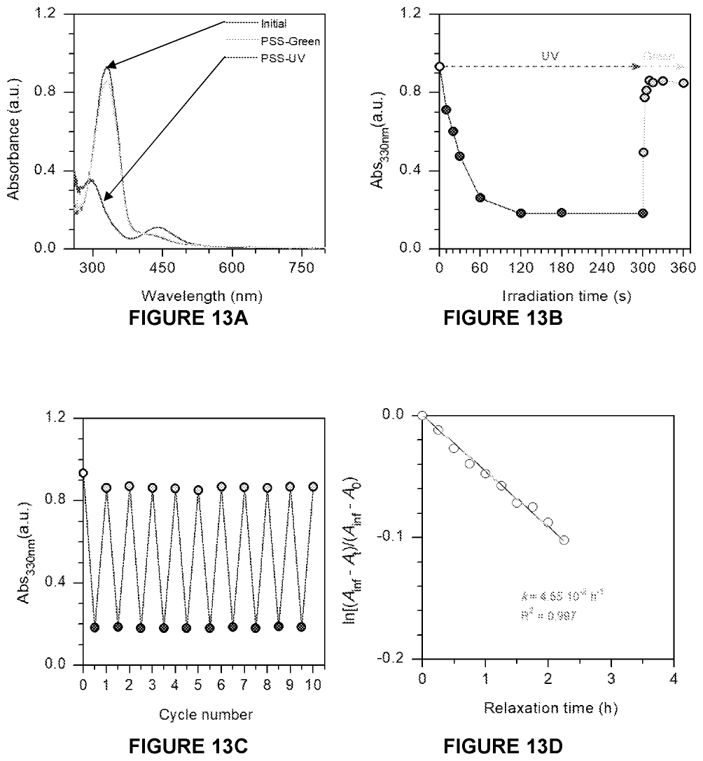

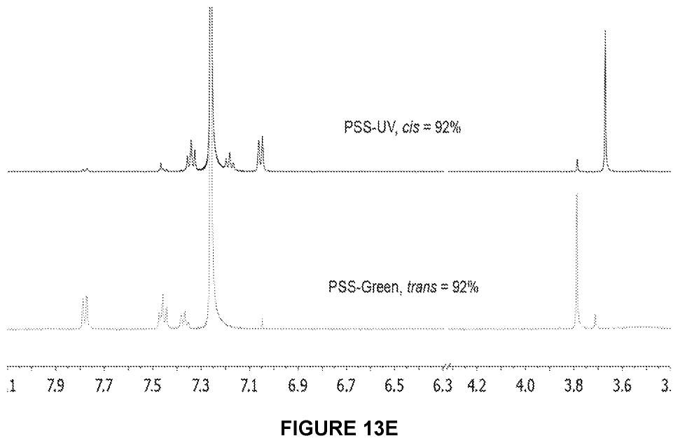

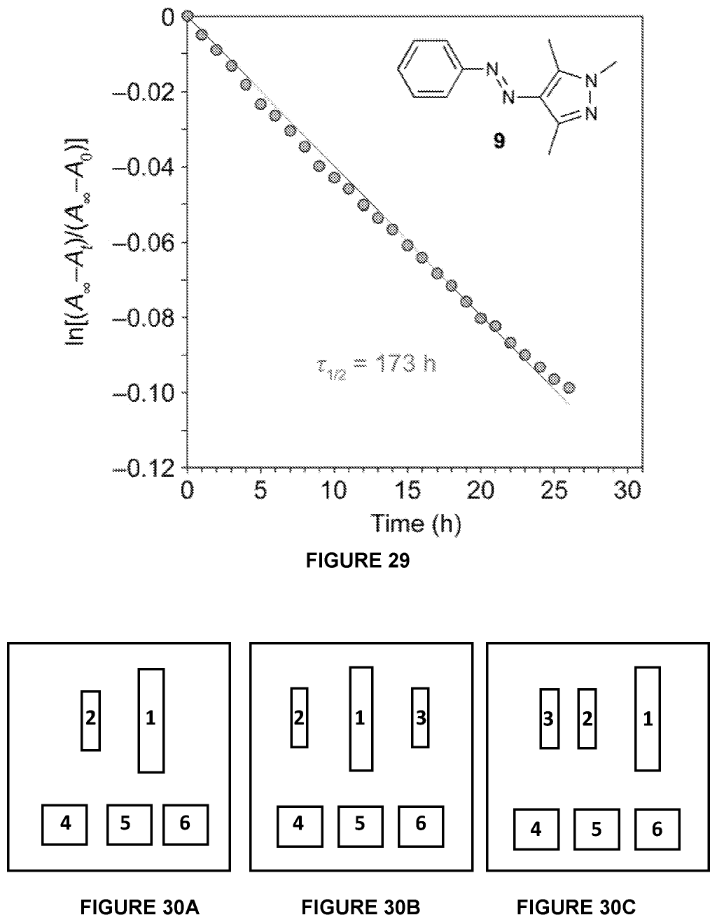

Phenylazotrimethylpyrazole 9 (FIG. 29) was prepared following a previously reported procedure. First, the thermal half-life of 9 in DMSO solution was determined as ˜173 h. Photoswitchable properties of 9 on PNN-roughened glass were then studied and the results are shown in FIG. 13. It was found that the thermal half-time of 9 within PNNs=15.2 h, i.e., 11.4 times faster than the solution (DMSO) value. The results show that the PNN-induced acceleration of the thermal relaxation of azopyrazole 9 was smaller than for azobenzenes 1-3, for which acceleration factors in the range 23.5-27 were found (FIG. 19).

1. A device comprising:
a substrate;
a porous structure layer attached to a surface said substrate, wherein the porous structure comprises filaments and has a surface area of between 10 m²/g and 10,000 m²/g; and
organic molecules incorporated within said porous structure;
wherein said organic molecules are photoswitchable such that when exposed to radiation of a certain wavelength, the structure of said molecules is changed.

2. The device of claim 1, wherein the material of said substrate comprises a metal, a metal alloy, a metal oxide or any combination thereof.

3. The device of claim 2, wherein said metal oxide is selected from the group consisting of: silicon oxide, tin oxide, indium tin oxide, alumina or any combination thereof.

4. The device of claim 1, wherein said substrate is optically transparent in the visible light range, in the UV light range, or in a combination thereof.

5. The device of claim 1, wherein said porous structure comprises polysiloxane.

6. The device of claim 1, wherein said porous structure is optically transparent in the visible light range, in the UV light range or in the combination thereof.

7. The device of claim 1, wherein the pores in said structure are micropores, nanopores or a combination thereof.

8. The device of claim 1, wherein said porous structure is superhydrophobic.

9. The device of claim 1, wherein said porous structure comprises a porous network of said filaments.

10. The device of claim 10, wherein said porous network of filaments comprises polysiloxane filaments.

11. The device of claim 1, wherein the thickness of said porous structure layer ranges between 10 nm and 1 mm.

12. The device of claim 11, wherein the thickness of said porous structure layer ranges between 0.5 μm and 10 μm.

13. The device of claim 1, wherein said molecules are selected from the group consisting of: azo compounds, spiropyrans, stilbenes, indigos, diarylethenes and fulgides, or any combination thereof.

14. The device of claim 13, wherein said azo compounds is a compound of formula 1: 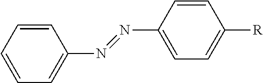
wherein R is OCH₃ (A1) or OCH₂C₂H₃ (A2) or O(CH₂CH₂O)₆(CH₂)₃SCOCH₃ (A3) or O(CH₂)₁₁SCOCH₃ (A7) or O(CH₂CH₂O)₃(CH₂)₃SCOCH₃ (A8).

15. The device of claim 13, wherein said azo compounds comprise compounds of formula 2: 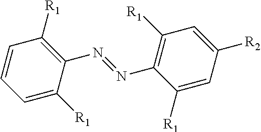
wherein R₁ is OCH₃ and R₂ is H (A4) or wherein R₁ is F and R2 is OCH₃ (A5).

16. The device of claim 13, wherein said azo compounds comprise compounds of formula 3 (A6):

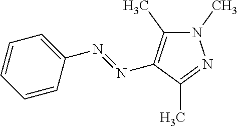 [SMILES: Cc1nn(C)c(C)c1/N=N/c1ccccc1]

17. The device of claim 1, wherein upon said structure change, the absorption spectra of said molecules changes.

18. The device of claim 1, wherein upon structure change, the molecules switch from color-visible to transparent or from transparent to color-visible.

19. The device of claim 1, wherein upon said structure change, the molecules switch from exhibiting one color to exhibiting a different color, or wherein upon said structure change the molecules switch from exhibiting color with a certain intensity to exhibiting the same color with a different intensity.

20. The device of claim 1, wherein said structure change comprises transformation from a first isomer to a second isomer of said molecule.

21. The device of claim 20, wherein said first isomer and said second isomer are stereoisomers.

22. The device of claim 20, wherein said first isomer and said second isomer are structural isomers.

23. The device of claim 1, wherein the dimensions of the device parallel to the substrate surface comprise length and width ranging between 1 mm and 10 m, and the thickness of the device measured perpendicular to the substrate surface is ranging between 10 nm and 1 mm.

24. A method of changing an initial color of a device, said method comprising:
providing a device comprising:
a substrate;
a porous structure attached to a surface of said substrate, wherein the porous structure comprises filament and has a surface area of between 10 m²/g and 10,000 m²/g; and
organic molecules incorporated within said porous structure;
wherein said organic molecules are photoswitchable such that when exposed to radiation of a certain wavelength, the structure of said molecules is changed;
irradiating said device with light of a first wavelength, thus inducing molecular structural or conformation or configuration change; thereby changing the color of said device.

25. The method of claim 24, wherein said color change comprising change of absorption spectra of said organic molecules.

26. The method of claim 24, wherein said substrate is transparent.

27. The method of claim 24, wherein said irradiating wavelength is in the UV or in the visible range.

28. The method of claim 24, wherein said color change is reversible.

29. The method of claim 28, wherein said method further comprising irradiating said device with light of a second wavelength, thus changing the color of said device back to said initial color.

30. The method of claim 29, wherein after irradiating said device with light of a first wavelength, the device is kept for a period of time without being irradiated until the color of said device changes back to said initial color.

31-43. (canceled)
